(19) United States
(12) Patent Application Publication
(10) Pub. No.: US 2019/0044617 A1
(43) Pub. Date: Feb. 7, 2019

(54) TRANSMISSION SYSTEM AND METHOD OF A FRAME TRANSMISSION

(71) Applicant: FUJITSU LIMITED, Kawasaki-shi (JP)

(72) Inventor: SHINGO NAKAMURA, Kawasaki (JP)

(73) Assignee: FUJITSU LIMITED, Kawasaki-shi (JP)

(21) Appl. No.: 16/050,229

(22) Filed: Jul. 31, 2018

(30) Foreign Application Priority Data
Aug. 3, 2017 (JP) 2017-150555

(51) Int. Cl. H04B 10/27; H04J 14/02; H04J 14/08

(52) U.S. Cl. CPC H04B 10/27; H04J 14/08; H04J 14/02

(57) ABSTRACT

A transmission system includes a first optical communicating device, and second optical communicating devices, the first optical communicating device transmits, to the second optical communicating devices, a first frame and an instruction whether to transmit the first frame to a radio communicating device corresponding to each of the second optical communicating devices, each of the second optical communicating devices receives the first frame and the instruction from the first optical communicating device, control, based on the instruction, whether to transmit the received first frame to the radio communicating device, and the first optical communicating device is configured to, based on a request from the radio communicating device, generates the instruction such that the first frame is to be transmitted to a mobile terminal device through two or more radio communicating devices.

### CROSS-REFERENCE TO RELATED APPLICATION

This application is based upon and claims the benefit of priority of the prior Japanese Patent Application No. 2017-150555, filed on Aug. 3, 2017, the entire contents of which are incorporated herein by reference.

### FIELD

The embodiments discussed herein re related to a transmission system and a method of a frame transmission.

### BACKGROUND

With the spread of mobile terminals such as smart phones, base stations coupling the mobile terminals to a radio communication network are increasing.

There are cases where a passive optical network (PON) in which the cost of optical fiber installation is low is used as a mobile backhaul network, which links a large number of base stations to an accommodating station on a high-level side. IEEE (the Institute of Electrical and Electrics Engineers, Inc.) 802.3ah, for example, defines a technology related to gigabit Ethernet (GE)-PON of 1 Gbps or more, the GE-PON conforming to Ethernet (registered trademark) (Ethernet is a registered trademark).

The PON is a star configuration access system optical network in which an optical terminal station device and a plurality of optical terminating devices are coupled to each other via an optical coupler that branches light. The optical terminal station device is referred to as an optical line termination (OLT) or the like. The optical terminating devices are referred to as optical network units (ONUs) or the like. The use of the PON as a mobile backhaul network provides advantages of, in addition to reducing the cost of optical fiber installation, being able to transmit the traffic of a plurality of base stations by one OLT. There is Japanese Laid-open Patent Publication No. 2010-199673 as a related-art document.

### SUMMARY

According to an aspect of the invention, a transmission system includes a first optical communicating device, and a plurality of second optical communicating devices coupled to the first optical communicating device through a plurality of optical transmission lines respectively, and coupled to a plurality of radio communicating devices respectively, wherein the first optical communicating device is configured to transmit a first frame to the plurality of second optical communicating devices, and transmit an instruction to the plurality of second optical communicating devices respectively, the instruction instructs each of the plurality of second optical communicating devices that whether to transmit the first frame to a radio communicating device corresponding to each of the plurality of second optical communicating devices, each of the plurality of second optical communicating devices is configured to receive the first frame and the instruction from the first optical communicating device, control, based on the instruction, whether to transmit the received first frame to the radio communicating device, and the first optical communicating device is configured to, based on a request from the radio communicating device, generates the instruction such that the first frame is to be transmitted to a mobile terminal device through two or more radio communicating devices.

This object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a transmission system;

FIG. 2 is a diagram illustrating a comparative example of a terminal management table and a group management table;

FIG. 3 is a block diagram illustrating an ONU according to a first embodiment;

FIG. 4 is a block diagram illustrating an OLT according to the first embodiment;

FIG. 5 is a diagram illustrating an example of a link management table, a terminal management table, and a group management table;

FIG. 6 is a diagram illustrating an example of unicast transmission;

FIG. 7 is a diagram illustrating an example of multicast transmission;

FIG. 8 is a diagram illustrating another example of multicast transmission;

FIG. 9 is a diagram illustrating example of a terminal management table;

FIG. 10 is a diagram illustrating examples of transfer tables;

FIG. 11 is a sequence diagram illustrating communication processing between an OLT and ONUs in the first embodiment;

FIG. 12 is a sequence diagram illustrating communication processing between an OLT and ONUs in a comparative example;

FIG. 13 is a flowchart illustrating an example of transmission processing of a down frame by an OLT;

FIG. 14 is a flowchart illustrating an example of reception processing of an up frame by an OLT;

FIG. 15 is a flowchart illustrating an example of reception processing of a down frame by an ONU;

FIG. 16 is block diagram illustrating an ONU according to a second embodiment;

FIG. 17 is a block diagram illustrating an OLT according to the second embodiment;

FIG. 18 is a diagram illustrating an example of a link management table and a group management table;

FIG. 19 is a diagram illustrating an example of unicast transmission;

FIG. 20 is a diagram illustrating an example of multicast transmission;

FIG. 21 is a diagram illustrating another example of multicast transmission;

FIG. 22 is a sequence diagram illustrating communication processing between an OLT and ONUs in the second embodiment;

FIG. 23 is a flowchart illustrating an example of transmission processing of a down frame by an OLT;

FIG. 24 is a flowchart illustrating an example of reception processing of an up frame by an OLT;

FIG. 25 is a flowchart illustrating an example of reception processing of a down frame by an ONU; and

FIG. 26 is a block diagram illustrating an example of an OLT of a time and wavelength division multiplexing (TWDM)-PON.

### DESCRIPTION OF EMBODIMENTS

Each base station uses radio waves in a same frequency band for communication. Therefore, when a mobile terminal is present at an edge portion of a cell of a base station (which edge portion will hereinafter be described as a “cell edge”), there is a fear that communication may become unstable due to radio wave interference from an adjacent cell. On the other hand, a coordinated multi-point (CoMP) technology is studied to realize cooperative communication between cells in long term evolution (LTE)-Advanced communication.

In a case where CoMP is used, an accommodating station transmits and receives same data to and from a plurality of base stations whose cells are adjacent to each other with a low delay, and thereby complements data lost due to a communication error. When COMP is applied to a PON, the same data may be transmitted by multicast from an OLT to a plurality of ONUs to which the respective base stations are coupled, and therefore a data delay may be reduced.

However, when a mobile terminal moves at a cell edge, and enters a region of a new cell, a group of ONUs as multicast targets (which group will hereinafter be described as a “multicast group”) also changes. When multicast settings are changed in the OLT and the plurality of ONUs each time the multicast group thus changes as the mobile terminal moves, a start of CoMP communication is delayed due to a processing time for the changing of the multicast settings.

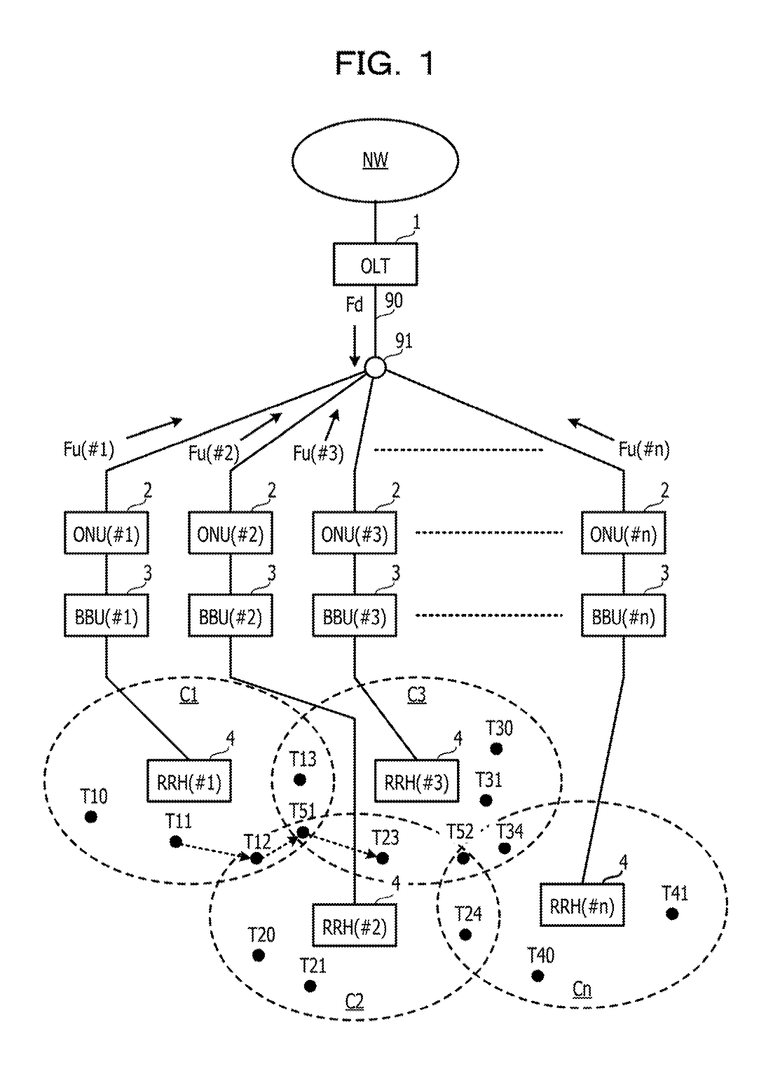

FIG. 1 is a block diagram illustrating an example of a transmission system. The transmission system includes an OLT 1, a plurality of ONUs (#1 to #n) (n: an integer of two or more) 2, a plurality of base band units (BBUs) (#1 to #n) 3, and a plurality of remote radio heads (RRHs) (#1 to #n) 4. Incidentally, the OLT 1 is an example of a transmitting device, and the BBUs 3 and the RRHs 4 are an example of communicating devices.

The OLT 1 is, for example, an optical terminal station device installed in a building of a carrier. The ONUs 2 are, for example, an optical terminating device housed in an outdoor cabinet or the like. The OLT 1 is coupled to the plurality of ONUs 2 via an optical fiber 90, which is an example of a transmission line. The optical fiber 90 is branched into a plurality of optical fibers by an optical splitter 91. The ONUs 2 are coupled to the respective branch destinations of the optical fiber 90.

The OLT 1 and the plurality of ONUs 2 thus constitute a PON. The PON is used as a mobile backhaul network that connects base stations in a radio communication network to an accommodating station on a high-level side. Incidentally, a GE-PON defined in IEEE 802.3ah is cited as an example of the PON. However, the PON is not limited to this.

The BBUs 3 and the RRHs 4 are couple to each other, and constitute base station devices. The accommodating station is coupled to a core network NW. The RRHs (#1 to #n) 4 include cells C1 to Cn of given ranges, and communicate with one or more mobile terminals T10 to T13, T20, T21, T23, T24, T30, T31, T34, T40, T41, T51, and T52 (hereinafter described as Tx) present within the cells C1 to Cn. Incidentally, smart phones or the like are cited as the mobile terminals Tx.

The OLT 1 is coupled to the core network NW on a service network interface (SNI) side. Each of the ONUs 2 is coupled to the BBU 3 on a user network interface (UNI) side. The accommodating station and each of the BBUs 3 may therefore communicate with each other via the PON.

In the present specification, a transmission direction of going from the OLT 1 to each of the ONUs 2 will be described as a “down direction,” and a transmission direction of going from each of the ONUs 2 to the OLT 1 will be described as an “up direction.” The OLT 1 transmits a down frame Fd to each of the ONUs 2, and the ONUs (#1 to #n) 2 transmit up frames Fu (#1) to Fu (#n) to the OLT 1.

The ONUs 2 transmit the up frames Fu (#1) to Fu (#n) in timings specified from the OLT 1. Therefore, the up frames Fu (#1) to Fu (#n) do not collide with each other within the optical fiber 90.

In addition, the OLT 1 time-division-multiplexes and transmits down frames Fd addressed to the respective ONUs 2. Each of the ONUs 2 selects only the down frame Fd addressed to the own device and transmits the down frame Fd to the BBU 3, and discards the down frames Fd addressed to the other ONUs 2. Therefore, the down frames Fd are transmitted from the core network NW to the destination mobile terminals Tx via the PON. Incidentally, Ethernet frames are cited as the up frames Fu and the down frames Fd, but the up frames Fu and the down frames Fd are not limited thereto.

Each RRH 4 communicates with the mobile terminals Tx using radio waves in a same frequency band. Therefore, when a mobile terminal Tx is present at a cell edge, there is a fear that communication may become unstable due to radio wave interference from an adjacent cell C1 to Cn. For example, the mobile terminals T10 to T13 and T51 communicate with the RRH (#1) 4 within the cell C1, and the mobile terminal T12 is located at a cell edge overlapping the adjacent cell C2. Therefore, the mobile terminal T12 may be subjected to radio wave interference from the cell C2.

In addition, the mobile terminal T13 is located at a cell edge overlapping the adjacent cell C3, and may therefore be subjected to radio wave interference from the cell C3. The mobile terminal T51 is located at a cell edge overlapping the adjacent cells C2 and C3, and may therefore be subjected to radio wave interference from the cells C2 and C3. Incidentally, other mobile terminals T23, T24, T34, and T52 present at cell edges may also be subjected to radio wave interference from the adjacent cells C2, C3, and Cn as in the foregoing.

On the other hand, a CoMP technology is used to realize cooperative communication between cells. When COMP is used, the accommodating station transmits and receives same data to and from the plurality of BBUs 3 whose cells C1 to Cn are adjacent to each other with a low delay, and thereby complements data lost due to a communication error. When COMP is applied to the PON, the same data may be transmitted by multicast from the OLT 1 to the plurality of ONUs 2 to which the respective BBUs 3 are coupled, and therefore a data delay may be reduced.

The OLT 1, for example, manages correspondence relations between the ONUs 2 and the mobile terminals Tx by a terminal management table 181, and manages multicast groups of the ONUs 2 by a group management table 182.

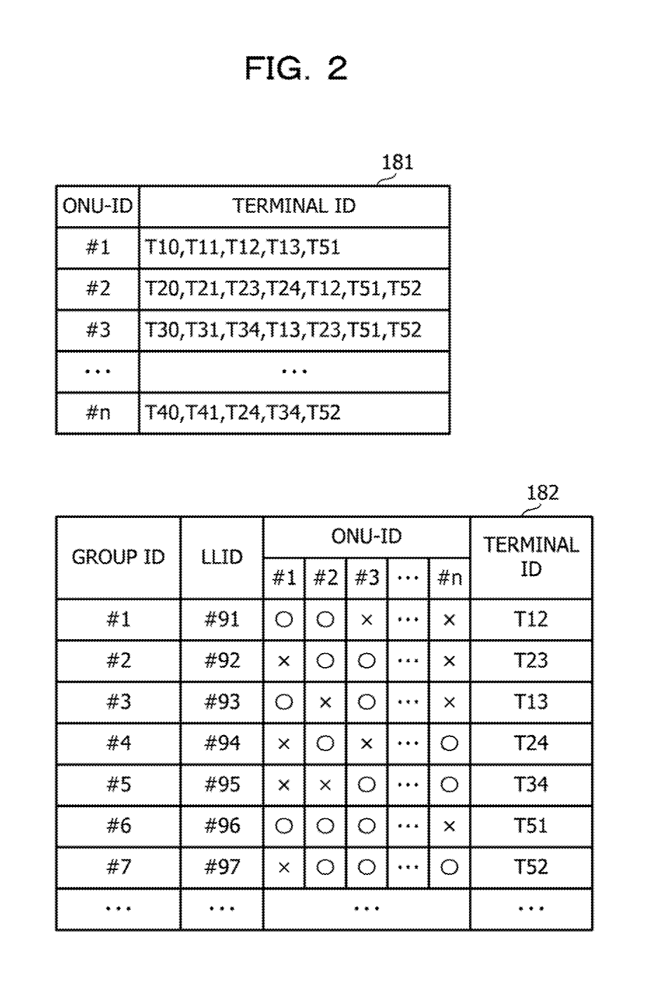

FIG. 2 is a diagram illustrating a comparative example of the terminal management table 181 and the group management table 182. Registered in the terminal management table 181 are ONU-IDs (#1 to #n) identifying the ONUs 2 and terminal IDs identifying the mobile terminals Tx. The terminal IDs are, for example, the media access control (MAC) addresses of the mobile terminals Tx. In the present example, the terminal IDs are the reference symbols (T10 and the like) of the mobile terminals Tx illustrated in FIG. 1.

For example, T10 to T13 and T51 are associated as terminal IDs with the ONU-ID #1. It is therefore indicated that the ONU (#1) 2 corresponds to the mobile terminals T10 to T13 and T51 within the cell C1. The OLT 1 obtains the correspondence relations between the ONUs 2 and the mobile terminals Tx from terminal information transmitted from each of the BBUs 3, for example, and registers the correspondence relations between the ONUs 2 and the mobile terminals Tx in the terminal management table 181. The terminal information includes the terminal IDs (MAC addresses) of the mobile terminals Tx as communication destinations of the BBUs Us 3 (the RRHs 4).

In the group management table 182, a group ID identifying a multicast group, a logical link identifier (LLID) identifying a logical line within the PON, ONU-IDs, and a terminal ID are registered so as to be associated with each other. Incidentally, as regards the ONU-IDs, circle marks are illustrated in the fields of the corresponding ONU-IDs, and cross marks are illustrated in the fields of the non-corresponding ON-IDs. For example, the ONU (#1) 2 and the ONU (#2) 2 belong to a multicast group #1, and the ONU (#2) 2 and the ONU (#3) 2 belong to a multicast group #2.

The OLT 1 sets a multicast group of a plurality of ONUs 2 corresponding to a mobile terminal Tx present at a cell edge in response to a request from a BBU 3, and registers the multicast group in the group management table 182. The request from the BBU 3, for example, indicates the terminal ID of the mobile terminal Tx that is present at the cell edge and is to be set as a CoMP target. The BBU 3, for example, detects the mobile terminal Tx as the CoMP target based on, a signal-to-noise (SN) ratio of communication of the mobile terminal Tx or the like.

When the OLT 1 receives a request from the BBU (#1) 3 as regards the mobile terminal T12 at the cell edge, for example, the OLT 1 retrieves the ONU-IDs “#1” and “#2” corresponding to the terminal ID “T12” from the terminal management table 181. The OLT 1 thereby sets the multicast group #1 to which the ONU (#1) 2 and the ONU (#2) 2 belong. Incidentally, also when the OLT 1 receives requests from BBUs 3 as regards the mobile terminals T23, T13, T24, T34, T51, and 152 at other cell edges, the OLT 1 sets multicast groups #2 to #7 based on the ONU-IDs retrieved from the terminal management table 181.

In addition, the OLT 1 assigns LLIDs to the multicast groups, and registers the LLIDs in the group management table 182. For example, an LLID “#91” is assigned to the multicast group #1. Incidentally, the LLID is an example of a logical line identifier.

The OLT 1 adds the LLID “#91” to a down frame Fd, addressed to the mobile terminal T12. The ONU (#1) 2 and the ONU (#2) 2 belonging to the multicast group #1 receive the down frame Fd to which the LLID “#91” is added. The down frame Fd addressed to the mobile terminal T12 is thereby transmitted to the mobile terminal 112 via the ONU (#1) 2 and the ONU (#2) 2.

In addition, an LLID “#92” is assigned to the multicast group #2. The OLT 1 adds the LLID “#92” to a down frame Fd addressed to the mobile terminal T23. The ONU (#2) 2 and the ONU (#3) 2 belonging to the multicast group #1 receive the down frame Fd to which the LLID “#92” is added. The down frame Fd addressed to the mobile terminal T23 is thereby transmitted to the mobile terminal T23 via the ONU (#2) 2 and the ONU (#3) 2.

However, when the mobile terminal Tx moves at a cell edge, and enters a region of a new cell, the multicast group also changes. When multicast settings are changed in the OLT and the plurality of ONUs each time the multicast group thus changes as the mobile terminal Tx moves, a start of CoMP communication may be delayed due to a processing time for the changing of the multicast settings.

Suppose that, as indicated by a dotted line arrow in FIG. 1, for example, the mobile terminal Tx moves to the respective positions of the mobile terminals T11, T12, T51, and T23 in this order. In this case, the OLT 1 needs to change the multicast group according to the movement of the mobile terminal Tx.

For example, when the mobile terminal Tx moves to the position of the mobile terminal T12, the OLT 1 sets the multicast group #1 in FIG. 2, and when the mobile terminal Tx moves to the position of the mobile terminal T51, the OLT 1 sets the multicast group #6 in FIG. 2. In addition, when the mobile terminal Tx moves to the position of the mobile terminal T23, the OLT 1 sets the multicast group #2 in FIG. 2.

As the number of cells is increased, multicast groups are increased, and the frequency of setting changes of the multicast groups is increased. In the comparative example, the multicast groups are assigned LLIDs identifying logical lines within the PON. Thus, complex setting processing needs to be performed in both the OLT 1 and the ONUs 2, and a start of CoMP communication may be delayed due to the processing time of the complex setting processing.

### First Embodiment

Accordingly, an OLT 1 according to a first embodiment transmits a down frame Fd to all of ONUs 2 by broadcast, and generates a multicast group by setting the down frame Fd to be transmitted from an ONU 2 to a BBU 3 by using a terminal ID. The ONU 2 receives all down frames Fd from the OLT 1, but transmits only the down frame Fd having the set terminal ID as a destination to the BBU 3.

Hence, the OLT 1 may quickly change the multicast group in response to the movement of the mobile terminal Tx by setting the multicast group by the terminal ID of the mobile terminal Tx as a CoMP target according to a request from the BBU 3.

In the present specification, broadcast is a transmission system that sets all of the ONUs 2 as transmission destinations, whereas multicast is a transmission system that sets at least a part of the ONUs 2 as transmission destinations. The OLT 1 transmits a down frame Fd by broadcast by adding, to the down frame Fd, a broadcast LLID #k (k: a positive integer) as the identifier of a common logical line between the OLT 1 and each ONU (#1 to #n) 2.

The ONUs 2 receive the down frame Fd to which the given broadcast LLID #k is added. Therefore, the OLT 1 does not need to set the broadcast LLID each time the mobile terminal Tx moves, and may thus change the multicast group easily. Configurations of the OLT 1 and the ONUs 2 will be described in the following.

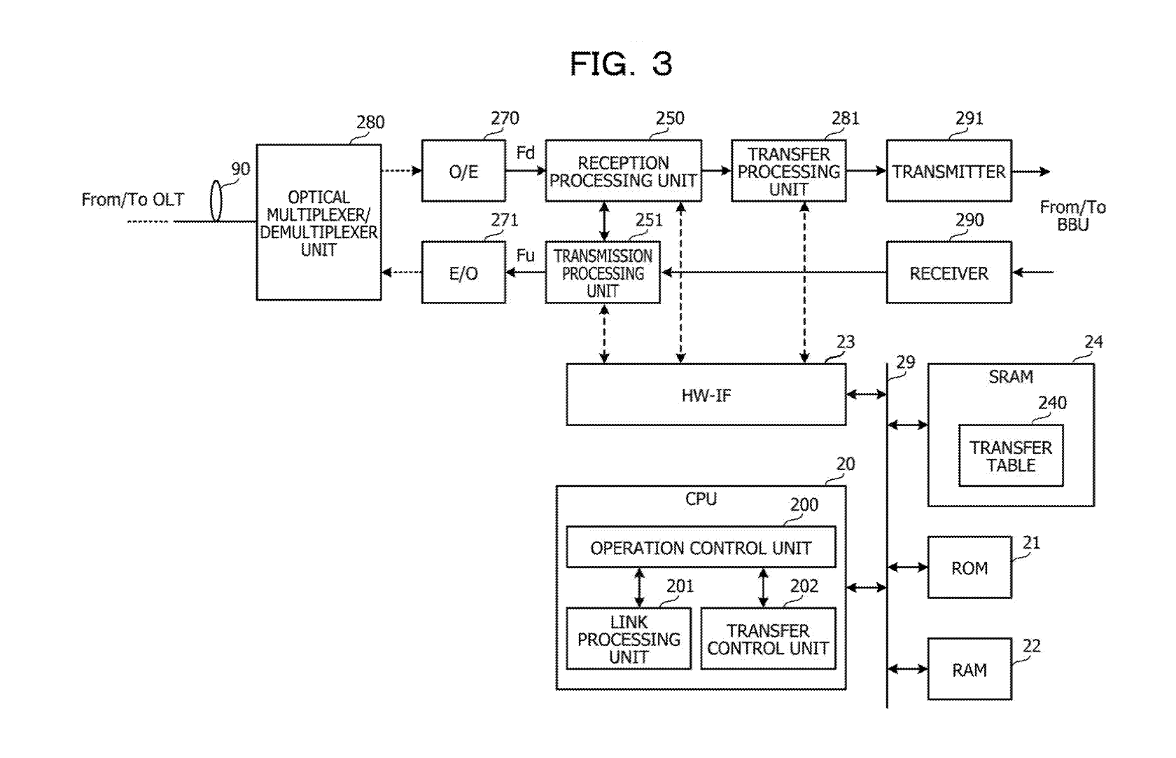

FIG. 3 is a block diagram illustrating an ONU 2 according to the first embodiment. The ONU 2 includes a central processing unit (CPU) 20, a read only memory (ROM) 21, a random access memory (RAM) 22, a hardware interface unit (HW-IF) 23, and a Static RAM (SRAM) 24, The ONU 2 also includes an optical multiplexer/demultiplexer unit 280, an optical-to-electrical converting unit (O/E) 270, an electrical-to-optical converting unit (E/O) 271, a reception processing unit 250, a transmission processing unit 251, a transfer processing unit 281, a receiver 290, and a transmitter 291.

The optical multiplexer/demultiplexer unit 280 is a WDM coupler, for example. The optical multiplexer/demultiplexer unit 280 guides, to the optical-to-electrical converting unit 270, an optical signal input from the OLT 1 via an optical fiber 90, and guides, to the OLT 1 via the optical fiber 90, an optical signal input from the electrical-to-optical converting unit 271. Incidentally, dotted line arrows between the optical multiplexer/demultiplexer unit 280 and the optical-to-electrical converting unit 270 and between the optical multiplexer/demultiplexer unit 280 and the electrical-to-optical converting unit 271 indicate directions of output of the optical signals.

The optical-to-electrical converting unit 270 may, for example, include a circuit such as a photodiode. The optical-to-electrical converting unit 270 converts the optical signal input from the OLT 1 into an electric signal. The electric signal includes a down frame Fd. The down frame Fd is input from the optical-to-electrical converting unit 270 to the reception processing unit 250.

The reception processing unit 250 performs reception processing of the down frame Fd. The reception processing unit 250 is an example of a first receiving unit, and receives the down frame Fd from the OLT 1 via the optical fiber 90.

For example, the reception processing unit 250 detects an LLID added to the down frame Fd, and determines whether the down frame Fd may be received based on the LLID. For example, the reception processing unit 250 determines whether or not the down frame Fd is addressed to the own device based on the LLID.

The reception processing unit 250 receives the down frame Fd when detecting an individual LLID assigned from the OLT 1 at a time of establishment of a link to the OLT 1, or when detecting a broadcast LLID, and discards the down frame Fd when detecting other LLIDs. Each of the ONUs 2 may therefore receive only down frames Fd addressed to the own device. Incidentally, in the present example, the LLIDs of multicast groups are not used.

The reception processing unit 250 deletes the LLID from the down frame Fd received from the OLT 1. Therefore, an amount of data transmitted to the BBU 3 is reduced by an amount corresponding to the LLID.

In addition, the reception processing unit 250, for example, detects a control frame including a control message addressed to the own device from the OLT 1 among down frames Fd by a given identifier (for example, OpCode), and outputs the control message to the CPU 20 via the HW-IF 23. The reception processing unit 250 outputs other down frames Fd addressed to the mobile terminal Tx to the transfer processing unit 281. Incidentally, the reception processing unit 250 may, for example, include a logic circuit such as field programmable gate array (FPGA) or an application specified integrated circuit (ASIC).

The transfer processing unit 281, for example, has functions of a Layer 2 switch. The transfer processing unit 281 transfers a down frame Fd from the reception processing unit 250 to the transmitter 291 based on a transfer setting from the CPU 20. Incidentally, while only one transmitter 291 is coupled to the transfer processing unit 281 in the present example, a plurality of transmitters 291 may be coupled to the transfer processing unit 281.

The CPU 20 receives an instruction for a transfer setting as a control message from the OLT 1. The transfer setting is made by the terminal ID (for example, the MAC address) of the mobile terminal Tx. The OLT 1 may therefore control the down frame Fd transferred from the reception processing unit 250 to the transmitter 291 by setting the terminal ID as the destination (DA: destination address) of the down frame Fd in the transfer processing unit 281.

The OLT 1 thereby controls the down frame Fd transmitted from the ONU 2 to the BBU 3. Hence, the mobile terminal Tx may receive the down frame Fd addressed to the own device from the ONU 2 to which the BBU 3 and the RRH 4 are coupled. Incidentally, the transfer processing unit 281 may, for example, include a logic circuit such as an FPGA or an ASIC.

The transmitter 291 is an example of a first transmitting unit. The transmitter 291 transmits the down frame Fd to the BBU 3. The transmitter 291, for example, has functions of the physical (PHY) layer and the MAC layer. The transmitter 291 performs given conversion processing of the down frame Fd, and transmits the down frame Fd. Incidentally, the transmitter 291 may, for example, include a logic circuit such as an FPGA or an ASIC.

The receiver 290 receives data from the BBU 3, and generates an up frame Fu. The receiver 290 outputs the up frame Fu to the transmission processing unit 251. Incidentally, the receiver 290 may, for example, include a logic circuit such as an FPGA or an ASIC.

The transmission processing unit 251 performs transmission processing of the up frame Fu. The transmission processing unit 251 performs the transmission processing in timing specified in a control message from the OLT 1 at a time of establishment of a link to the OLT 1. The transmission processing unit 251 adds, to the up frame Fu, the individual LLID of the own ONU 2, the individual LLID being assigned from the OLT 1, and outputs the up frame Fu to the electrical-to-optical converting unit 271.

In addition, the transmission processing unit 251 generates a control frame including a control message input from the CPU 20 via the HW-IF 23. The transmission processing unit 251 outputs the control frame as an up frame Fu to the electrical-to-optical converting unit 271. In addition, the transmission processing unit 251 outputs an up frame Fu including a multicast request from the BBU 3 or the terminal information of a communication destination of the BBU 3 (the RRH 4) to the electrical-to-optical converting unit 271. Incidentally, the transmission processing unit 251 may, for example, include a logic circuit such as an FPGA or an ASIC.

The electrical-to-optical converting unit 271 may, for example, include a circuit including a laser diode or the like. The electrical-to-optical converting unit 271 converts an electric signal including the up frame Fu into an optical signal, and outputs the optical signal to the optical multiplexer/demultiplexer unit 280.

The CPU 20 is coupled to the ROM 21, the RAM 22, the HW-IF 23, and the SRAM 24 via a bus 29 so that signals may be input and output mutually. Incidentally, another processor such as a microprocessor unit (MPU) may be used in place of the CPU 20.

The ROM 21 stores a program that drives the CPU 20. The RAM 22 functions as a working memory for the CPU 20. The HW-IF 23 relays communications between the CPU 20 and the transmission processing unit 251, the reception processing unit 250, and the transfer processing unit 281 by coupling the transmission processing unit 251, the reception processing unit 250, and the transfer processing unit 281 to the bus 29 (see dotted line arrows). Incidentally, the HW-IF 23 may, for example, include a logic circuit such as an FPGA or an ASIC.

The SRAM 24 stores a transfer table 240 indicating the contents of transfer settings of the transfer processing unit 281. Registered in the transfer table 240 are the terminal IDs of destinations of down frames Fd that the transfer processing unit 281 transfers from the reception processing unit 250 to the transmitter 291.

When the CPU 20 reads the program from the ROM 21, the following are formed as functions: an operation control unit 200, a link processing unit 201, and a transfer control unit 202. The operation control unit 200 controls operation of the whole of the ONU 2, and gives instructions for operation to the link processing unit 201 and the transfer control unit 202 according to a given sequence. Incidentally, the operation control unit 200, the link processing unit 201, and the transfer control unit 202 may, for example, include a logic circuit such as an FPGA or an ASIC.

The link processing unit 201 processes establishment of a link to the OLT 1. The link processing unit 201 transmits and receives given control messages to and from the OLT 1. The link processing unit 201 is thereby assigned the individual LLID of the own ONU 2 from the OLT 1. The link processing unit 201 sets the individual LLID in the transmission processing unit 251.

Thus, the transmission processing unit 251 adds the individual LLID to the up frame Fu. The OLT 1 determines the ONU 2 as a transmission source of the up frame Fu by detecting the individual LLID.

In addition, the transfer control unit 202 performs transfer processing in the transfer processing unit 281 according to a transfer setting instruction included in a control message from the OLT 1 after the establishment of the link to the OLT 1. The transfer setting instruction includes at least one of the terminal ID of the destination of a down frame Fd to be transferred and the terminal ID of the destination of a down frame Fd not to be transferred (for example, to be discarded). The transfer control unit 202 updates the transfer table 240 according to the transfer setting instruction, and sets the transfer processing unit 281 via the HW-IF 23 based on the transfer table 240 after being updated.

The OLT 1 adds the broadcast LLID to all down frames Fd, as described above. The reception processing unit 250 of each of the ONUs 2 therefore receives the same down frames Fd.

In addition, the OLT 1 sets, in the transfer processing unit 281 of each of the ONUs 2, the terminal IDs of mobile terminals Tx corresponding to the ONU 2. The transmitter 291 of each of the ONUs 2 may therefore transmit down frames Fd to the mobile terminals Tx corresponding to the ONU 2.

The OLT 1 sets the transfer processing unit 281 of each of the ONUs 2 such that down frames Fd are transmitted to each mobile terminal Tx by unicast, and sets, in the transfer processing units 281 of a plurality of ONUs 2, the terminal ID of a common mobile terminal Tx present at a cell edge, in response to a multicast request from a BBU 3. The OLT 1 may thereby transmit a down frame Fd addressed to the common mobile terminal Tx to the multicast group. Incidentally, unicast is a transmission system that sets only one ONU 2 as a transmission destination.

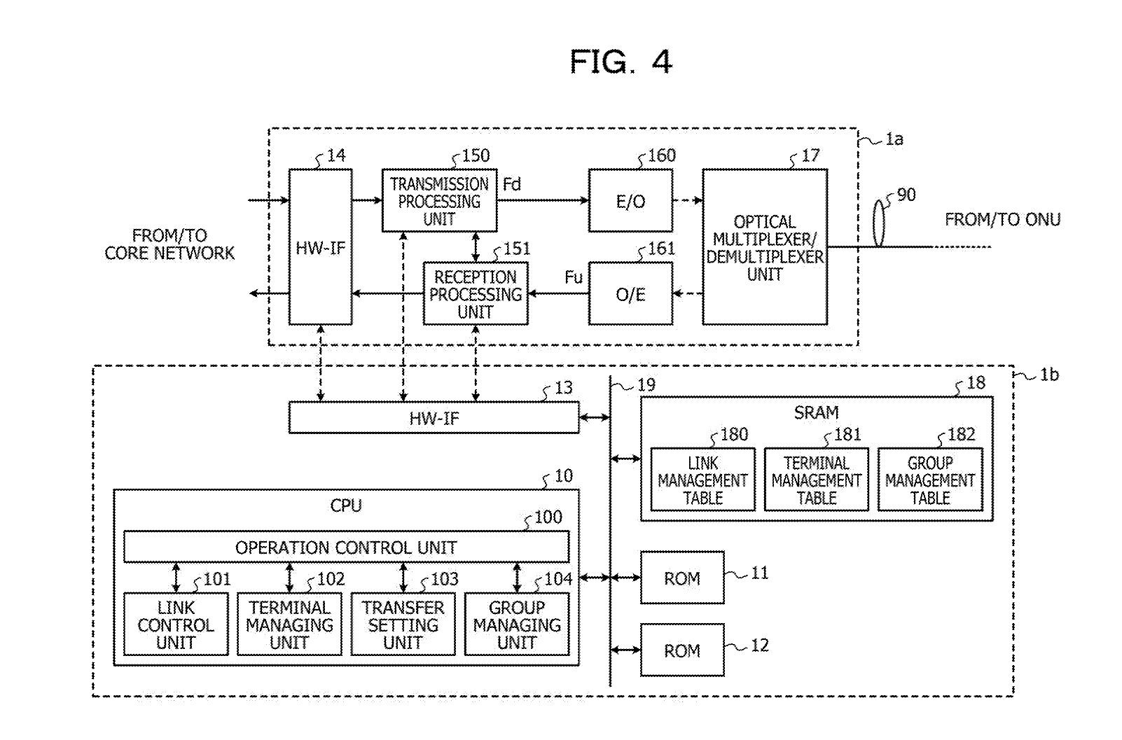

FIG. 4 is a block diagram illustrating the OLT 1 according to the first embodiment. The OLT 1 includes an optical interface unit 1a and a control unit 1b. The optical interface unit 1a performs transmission and reception processing of up frames Fu and down frames Fd. The control unit 1b performs various kinds of control by transmitting and receiving control messages to and from the ONUs 2.

The control unit 1b includes a CPU 10, a ROM 11, a RAM 12, an HW-IF 13, and an SRAM 18. The CPU 10 is coupled to the ROM 11, the RAM 12, the HW-IF 13, and the SRAM 18 via a bus 19 so that signals may be input and output mutually. Incidentally, another processor such as an MPU may be used in place of the CPU 10.

The optical interface unit la includes a network interface unit (NW-IF) 14, an optical multiplexer/demultiplexer unit 17, a transmission processing unit 150, a reception processing unit 151, an electrical-to-optical converting unit (E/O) 160, and an optical-to-electrical converting unit (O/E) 161.

The optical multiplexer/demultiplexer unit 17 is a WDM coupler, for example. The optical multiplexer/demultiplexer unit 17 guides, to the optical-to-electrical converting unit 161, an optical signal input from each of the ONUs 2 via the optical fiber 90, and guides, to each of the ONUs 2 via the optical fiber 90, an optical signal input from the electrical-to-optical converting unit 160. Incidentally, dotted line arrows between the optical multiplexer and the optical-to-electrical converting unit 161 and between the optical multiplexer/demultiplexer unit 17 and the electrical-to-optical converting unit 160 indicate directions of output of the optical signals.

The optical-to-electrical converting unit 161 may, for example, include a circuit such as a photodiode. The optical-to-electrical converting unit 161 converts the optical signal input from each of the ONUs 2 into an electric signal. The electric signal includes an up frame Fu. The up frame Fu is input from the optical-to-electrical converting unit 161 to the reception processing unit 151.

The reception processing unit 151 performs reception processing of the up frame Fu. The reception processing unit 151 is an example of a second receiving unit, and receives up frames Fu from the respective ONUs 2.

The reception processing unit 151 determines the ONU 2 a transmission source of the up frame Fu based on the individual LLID of the ONU 2, the individual LLID being added to the up frame Fu. The reception processing unit 151 deletes the LLID from the up frame Fu, and outputs the up frame Fu to the NW-IF 14.

In addition, the reception processing unit 151, for example, detects a control frame including a control message from each of the ONUs 2 among up frames Fu by a given identifier (for example, OpCode), and outputs the control message to the CPU 10 via the HW-IF 13.

In addition, the reception processing unit 151 detects, by a given identifier (for example, a Type area), an up frame Fu including terminal information and an up frame Fu including a multicast request for performing CoMP (hereinafter “multicast request”) among up frames Fu from the BBUs 3. The reception processing unit 151 outputs the terminal information and the multicast request to the CPU 10 via the HW-IF 13 together with information indicating ONUs 2 as transmission sources. The reception processing unit 151 outputs other up frames Fu to the NW-IF 14. Incidentally, the reception processing unit 151 may, for example, include a logic circuit such as an FPGA or an ASIC.

The NW-IF 14 converts the up frames Fu into a given format (for example, an asynchronous transfer mode (ATM) cell), and transmits the converted up frames Fu to the core network NW. In addition, the NW-IF 14 generates a down frame Fd from data (for example, an ATM cell) received from the core network NW, and outputs the down frame Fd to the transmission processing unit 150. Incidentally, the NW-IF 14 may, for example, include a logic circuit such as an FPGA or an ASIC.

The transmission processing unit 150 adds the broadcast LLID to the down frame Fd, and performs transmission processing of the down frame Fd. The transmission processing unit 150 is an example of a second transmitting unit, and transmits the same down frame Fd to each of the plurality of ONUs (#1 to #n) 2.

In the transmission processing unit 150, the LLID to be added to the down frame Fd is set from the CPU 10 via the HW-IF 13. The CPU 10 sets the broadcast LLID in the transmission processing unit 150. The transmission processing unit 150 thereby adds the broadcast LLID to the down frame Fd irrespective of an ONU 2 as a destination. Each of the ONUs (#1 to #n) 2 therefore receives the common down frame Fd. The transmission processing unit 150 outputs the down frame Fd to which the LLID is added to the electrical-to-optical converting unit 160.

In addition, the transmission processing unit 150 generates a control frame including a control message input from the CPU 10 via the HW-IF 13. The transmission processing unit 150 outputs the control frame as a down frame Fd to the electrical-to-optical converting unit 160. Incidentally, the transmission processing unit 150 may, for example, include a logic circuit such as an FPGA or an ASIC.

The electrical-to-optical converting unit 160 may, for example, include a circuit including a laser diode or the like. The electrical-to-optical converting unit 160 converts an electric signal including the down frame Fd into an optical signal, and outputs the optical signal to the optical multiplexer/demultiplexer unit 17.

The ROM 11 stores a program that drives the CPU 10. The RAM 12 functions as a working memory for the CPU 10. The HW-IF 13 relays communications between the CPU 10 and the transmission processing unit 150 and the reception processing unit 151 by coupling the transmission processing unit 150 and the reception processing unit 151 to the bus 19 (see dotted line arrows). Incidentally, the HW-IF 13 may, for example, include a logic circuit such as an FPGA or an ASIC.

The SRAM 18 stores a link management table 180, a terminal management table 181, and a group management table 182.

When the CPU 10 reads the program from the ROM 11, the following are formed as functions: an operation control unit 100, a link control unit 101, a terminal managing unit 102, a transfer setting unit 103, and a group managing unit 104. The operation control unit 100 controls operation of the whole of the OLT 1, and gives instructions for operation to the link control unit 101, the terminal managing unit 102, the transfer setting unit 103, and the group managing unit 104 according to a given sequence. Incidentally, the operation control unit 100, the link control unit 101, the terminal managing unit 102, the transfer setting unit 103, and the group managing unit 104 may, for example, include a logic circuit such as an FPGA or an ASIC.

The link control unit 101 establishes links to ONUs 2 by transmitting and receiving given control messages to and from the ONUs 2, The link control unit 101 registers the LLIDs used between the OLT 1 and the ONUs 2 to which the links are established in the link management table 180, and sets the LLIDs in the transmission processing unit 150 and the reception processing unit 151 based on the link management table 180.

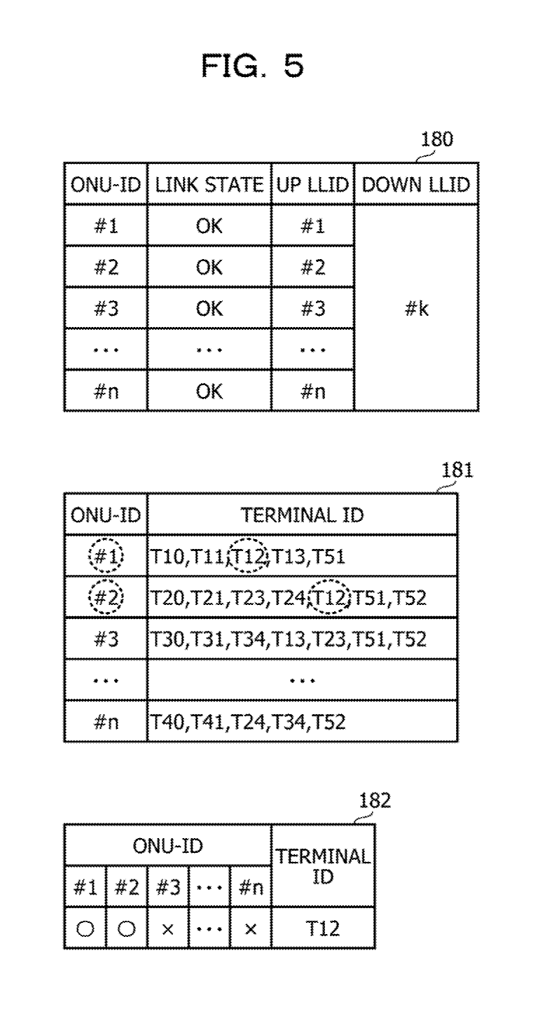

FIG. 5 illustrates an example of the link management table 180. Registered in the link management table 180 are ONU-IDs, the link state (OK: link up, NG: link down) of each of the ONUs 2, and LLIDs used between the OLT 1 and each of the ONUs 2. Up LLIDs are LLIDs added to up frames Fu, and the individual LLIDs (#1 to #n) of the respective ONUs 2 are set as the up LLIDs. A down LLID is an LLID added to down frames Fd, and the broadcast LLID (#k) is set as the down LLID.

The transmission processing unit 150 adds the broadcast LLID to down frames Fd according to the down LLID. In addition, the reception processing unit 151 determines an ONU 2 as a transmission source of an up frame Fu according to the up LLIDs, and notifies the ONU 2 as the transmission source of the up frame Fu to the CPU 10.

Referring to FIG. 4 again, the terminal managing unit 102 is an example of a registration processing unit, and registers correspondence relations between each of the ONUs 2 and the mobile terminals Tx in the terminal management table 181 based on terminal information from the BBUs 3. The terminal information indicates the terminal IDs of the mobile terminals Tx with which the BBUs 3 as transmission sources of the terminal information communicate via the RRHs 4, for example, the mobile terminals Tx as communication destinations.

FIG. 5 illustrates an example of the terminal management table 181. The terminal management table 181 has a configuration as described with reference to FIG. 2. The terminal management table 181 is used for transfer settings in the transfer processing unit 281 of each of the ONUs 2. Incidentally, the SRAM 18 is an example of a storage unit that stores the terminal management table 181.

Referring to FIG. 4 again, the transfer setting unit 103 is an example of a setting processing unit, and based on the terminal information, the transfer setting unit 103 sets the transfer processing unit 281 in each of the ONUs 2 such that down frames Fd addressed to mobile terminals Tx are transferred from the reception processing unit 250 to the transmitter 291.

The ONUs 2 transmit up frames Fu including the terminal information received from the BBUs 3 to the OLT 1 via the optical fiber 90, as described above, and the reception processing unit 151 of the OLT 1 receives the up frames Fu. The transfer setting unit 103 sets the transfer processing units 281 of the ONUs 2 based on the terminal information included in the received up frames Fu. The transfer setting unit 103 may therefore set the transfer processing units 281 more quickly than in a case where the terminal information is received from the BBUs 3 via another network than the PON.

For example, based on the terminal management table 181, the transfer setting unit 103 sets, in the transfer processing unit 281 of each of the ONUs 2, the terminal IDs of mobile terminals Tx as communication destinations of the BBU 3. Thus, the transfer processing unit 281 transfers down frames Fd addressed to the mobile terminals Tx as communication destinations of the BBU 3 from the reception processing unit 250 to the transmitter 291.

In addition, for a terminal ID registered in correspondence with a plurality of ONUs 2 because the mobile terminal Tx is present at a cell edge where two or more of the cells C1 to Cn overlap each other, the transfer processing unit 281 makes transfer settings in only the transfer processing unit 281 of an ONU 2 with which the terminal ID is first associated.

For example, the mobile terminal T12 in FIG. 1 is present at a cell edge of the cell C1, the cell edge overlapping the cell C2. The terminal ID “T12” is therefore registered in correspondence with the ONU-IDs “#1” and “#2” in the terminal management table 181 in FIG. 5 (see dotted line circles).

In this case, supposing that the terminal ID “T12” is first registered in association with the ONU-ID “#1,” the transfer setting unit 103 makes the transfer setting of the terminal ID “T12” in the transfer processing unit 281 of the ONU (#1) 2, but does not make the transfer setting of the terminal ID “T12” in the transfer processing unit 281 of the ONU (#2) 2. Therefore down frames Fd addressed to the mobile terminal T12 are transmitted to the ONU (#1) 2 by unicast. This is because an error or unnecessary traffic may occur when the down frames Fd are transmitted to the GNU (#1) 2 and the ONU (#2) 2 by multicast in a case where there is no need to perform CoMP.

In addition, the group managing unit 104 is an example of a determining unit, and determines two or more ONUs 2 based on the terminal management table 181 and a mobile terminal Tx indicated in a multicast request. For example, the group managing unit 104 generates a multicast group including the ONUs 2 corresponding to the mobile terminal Tx indicated in the multicast request by referring to the terminal management table 181. The group managing unit 104 may therefore generate the multicast group more quickly than in a case where the group managing unit 104 receives an instruction to generate the multicast group from a network monitoring control device, for example.

The group managing unit 104 generates the multicast group in response to the multicast request from a BBU 3, and registers the multicast group in the group management table 182. When the group managing unit 104 registers the multicast group, the group managing unit 104 notifies the transfer setting unit 103 via the operation control unit 100 that the multicast group is registered.

FIG. 5 illustrates an example of the group management table 182. The group management table 182 has ONU-IDs and a terminal ID registered therein in association with each other. Incidentally, the ONU-IDs of the ONUs 2 included in the multicast group are indicated by circle marks, and the ONU-IDs of the ONUs 2 not included in the multicast group are indicated by cross marks.

In the present example, the terminal ID “T12” is associated with the multicast group to which the ONU (#1) 2 and the ONU (#2) belong. Therefore down frames Fd addressed to the common mobile terminal T12 are transmitted to the ONU (#1) 2 and the ONU (#2) 2. Thus, the mobile terminal T12 may receive the same down frames Fd from the ONU (#1) 2 and the ONU (#2) 2, and perform communication based on the CoMP technology.

When the multicast group, is registered in the group management table 182 in response to the multicast request, the transfer setting unit 103 makes transfer settings based on the group management table 182 in the transfer processing unit 281 of each of the ONUs 2 belonging to the multicast group. In the above-described example, the transfer setting unit 103 sets the terminal ID “T12” in the respective transfer processing units 281 of the ONU (#1) 2 and the ONU (#2) 2 in response to the multicast request from the BBU 3 corresponding to the ONU (#1) 2. Here, the multicast request indicates the terminal ID “T12” of the mobile terminal T12 that is present at a cell edge and to be set as a target of CoMP communication.

For example, the transfer setting unit 103 outputs a control message for giving an instruction for a transfer setting in the transfer processing units 281 to the transmission processing unit 150. The transmission processing unit 150 generates a control frame including the control message, and transmits the control frame to each of the ONUs 2. The transfer setting unit 103 may therefore make the transfer setting in the transfer processing units 281 more quickly than in a case where the transfer processing units 281 are set via a network other than the PON.

Thus, in response to the request from the BBU 3, the transfer setting unit 103 sets the transfer processing units 281 in two or more ONUs 2 such that down frames Fd addressed to the common mobile terminal Tx are transferred from the reception processing unit 250 to the transmitter 291. Therefore, unlike the comparative example, the OLT 1 may save the trouble of setting an LLID common to the multicast group, and thus change the multicast group quickly according to movement of the mobile terminal Tx.

In addition, each of the ONUs 2 transmits an up frame Fu including a multicast request from the BBU 3 to the OLT 1 via the optical fiber 90, and the transfer setting unit 103 obtains the multicast request from the up frame Fu received by the reception processing unit 151. The transfer setting unit 103 may therefore obtain the multicast request more quickly than in a case where the multicast request is obtained from a network monitoring control device, for example.

Description w next be made of are example of transmission of a down frame Fd by the OLT 1.

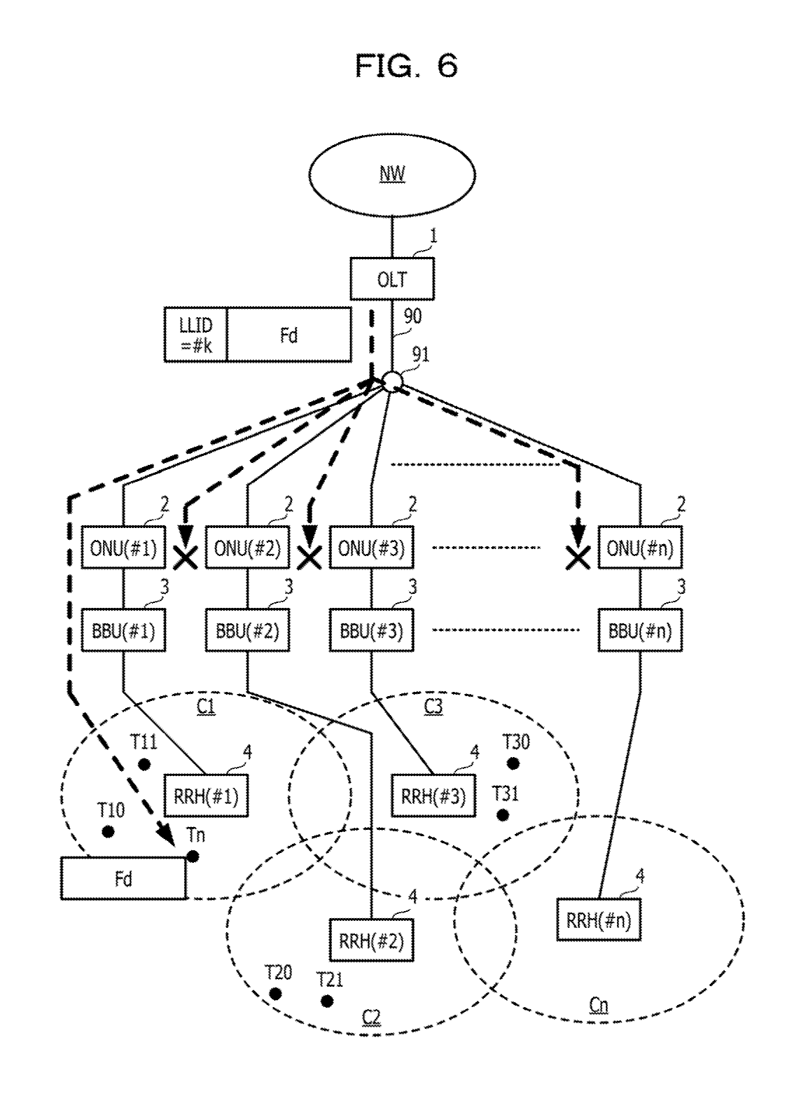

FIG. 6 is a diagram illustrating an example of unicast transmission. In FIG. 6, configurations common to FIG. 1 are identified by the same reference symbols, and description thereof will be omitted. Incidentally, thick dotted lines represent paths of a down frame Fd addressed to the mobile terminal Tn.

In the present example, the mobile terminals T10, T11, and Tn are present in the cell C1 corresponding to the ONU (#1) 2, and the mobile terminals T20 and T21 are present in the cell C2 corresponding to the ONU (#2) 2. In addition, the mobile terminals T30 and T31 are present in the cell C3 corresponding to the ONU (#3) 2, and there is no mobile terminal Tx in the cell Cn corresponding to the ONU (#n) 2. In addition, none of the mobile terminals T10, T11, Tn, T20, T21, T30, and T31 is located at a cell edge.

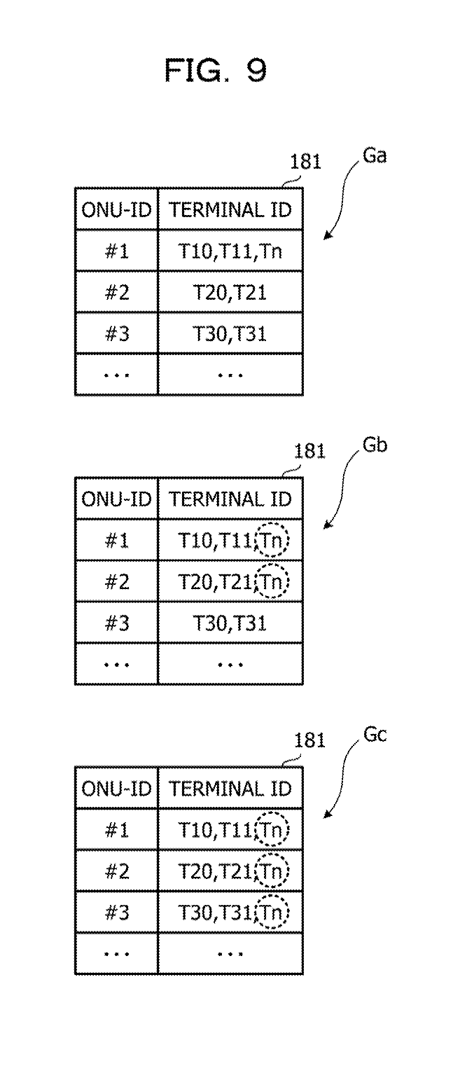

A reference symbol Ga in FIG. 9 denotes the terminal management table 181 in the present example. In the terminal management table 181, the mobile terminals T10, T11, and Tn are associated with the ONU (#1) 2, the mobile terminals T20 and T21 are associated with the ONU (#2) 2, and the mobile terminals T30 and T31 are associated with the ONU (#3) 2. The following description will be made of a change in the transfer settings of the transfer processing unit 281, the change accompanying movement of the mobile terminal Tn.

Referring to FIG. 6 again, the transmission processing unit 150 of the OLT 1 adds the broadcast LLID (#k) to all down frames Fd, and transmits the down frames Fd to each of the ONUs (#1 to #n) 2. The reception processing unit 250 of each of the ONUs 2 therefore receives the same down frames Fd.

The transfer setting unit 103 of the OLT 1 makes a transfer setting in the transfer processing unit 281 in the ONU (#1) 2 so that a down frame Fd addressed to the mobile terminal Tn within the cell C1 is transferred from the reception processing unit 250 to the transmitter 291 in the ONU (#1) 2. For example, the transfer setting unit 103 sets the terminal ID “Tn” in the transfer processing unit 281 of the ONU (#1) 2 based on terminal information from the BBU (#1) 3.

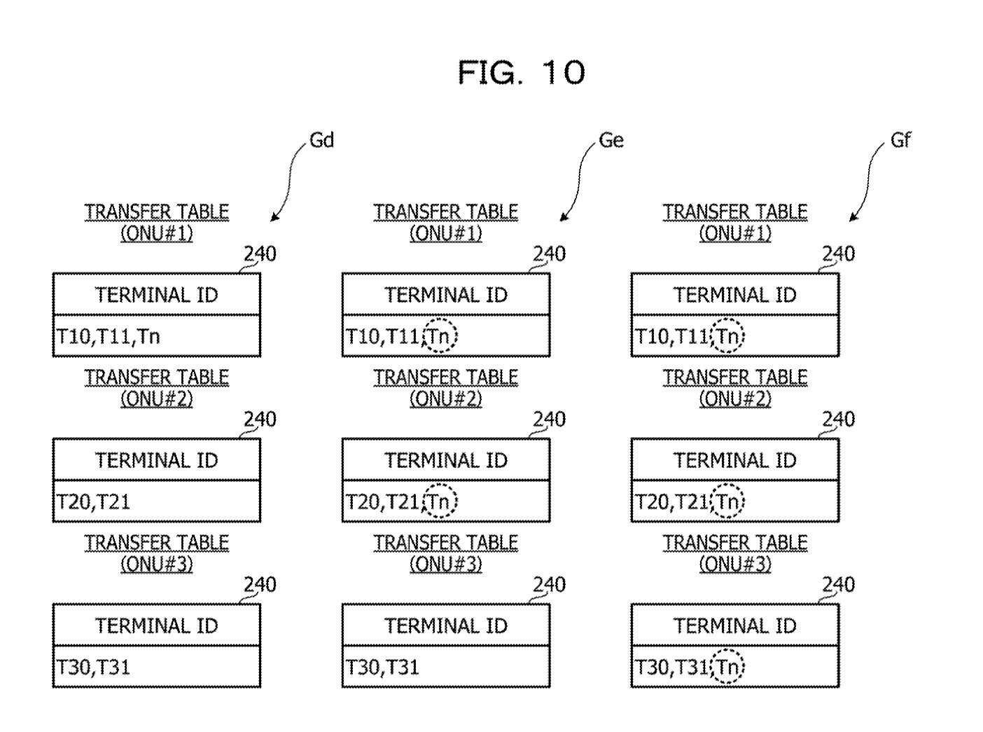

A reference symbol Gd in FIG. 10 indicates the respective transfer tables 240 of the ONU (#1) 2, the ONU (#2) 2, and the ONU (#3) 2. The terminal IDs “T10,” “T11,” and “Tn” are registered in the transfer table 240 of the ONU (#1) 2. The transfer processing unit 281 of the ONU (#1) 2 therefore transfers down frames Fd addressed to the mobile terminals T10, T11, and Tn from the reception processing unit 250 to the transmitter 291. Hence, the mobile terminals T10, T11, and Tn may receive the down frames Fd addressed to the own device via the ONU (#1) 2.

The terminal IDs “T20” and “T21” are registered in the transfer table 240 of the ONU (#2) 2. The transfer processing unit 281 of the ONU (#2) 2 therefore transfers down frames Fd addressed to the mobile terminals T20 and T21 from the reception processing unit 250 to the transmitter 291. Hence, the mobile terminals T20 and T21 may receive the down frames Fd addressed to the own devices via the ONU (#2) 2.

The terminal IDs “T30” and “T31” are registered in the transfer table 240 of the ONU (#3) 2. The transfer processing unit 281 of the ONU (#3) 2 therefore transfers down frames Fd addressed to the mobile terminals T30 and T31 from the reception processing unit 250 to the transmitter 291. Hence, the mobile terminals T30 and T31 may receive the down frames Fd addressed to the own device via the ONU (#3) 2. The transfer processing units 281 of the ONUs (#2 to #n) 2 do not have the terminal ID “Tn” set therein, and therefore discard down frames Fd addressed to the mobile terminal Tn.

Thus, when the mobile terminal Tn is not located at a cell edge, the OLT 1 transmits down frames Fd to the ONU (#1) 2 corresponding to the mobile terminal Tn by unicast.

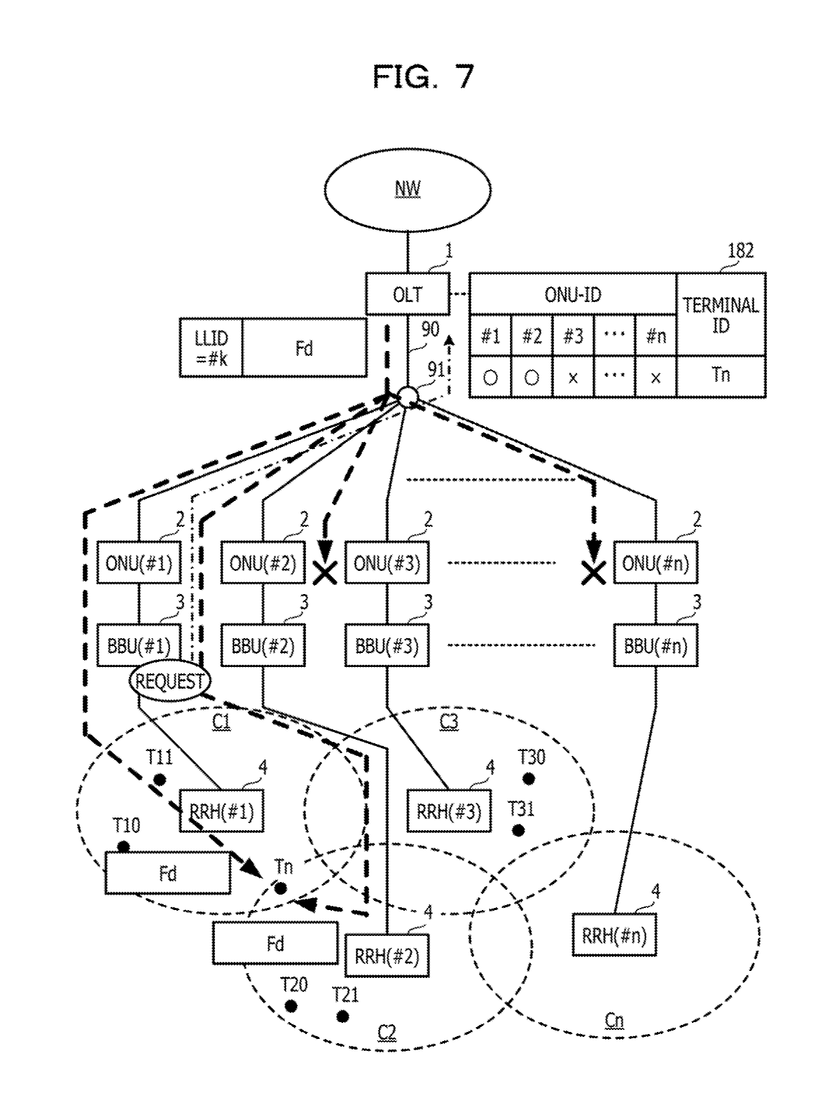

FIG. 7 is a diagram illustrating an example of multicast transmission. In FIG. 7, configurations common to FIG. 1 are identified by the same reference symbols, and description thereof will be omitted. Incidentally, thick dotted lines represent paths of a down frame Fd addressed to the mobile terminal Tn.

The mobile terminal Tn has moved position in FIG. 6 to a cell edge overlapping the cell C2.

A reference symbol Gb in FIG. 9 indicates the terminal management table 181 in the present example. As indicated by dotted line circles, the mobile terminal Tn is associated with the ONU (#1) 2 and the ONU (#2) 2 as the mobile terminal Tn moves. At this time, as described above, the OLT 1 does not give an instruction for transfer processing to the transfer processing unit 281 of the ONU (#2) 2 until receiving a multicast request so that an error or unnecessary traffic does not occur.

Referring to FIG. 7 again, the BBU (#1) 3 of the cell C1 determines, for example, based on an SN ratio, that the mobile terminal Tn is located at a cell edge and that CoMP communication is accordingly desired, and transmits an up frame Fu including a multicast request to the OLT 1 (see alternate long and short dashed lines). Incidentally, the multicast request indicates the terminal ID “Tn” of the mobile terminal Tn as a CoMP target.

In response to the multicast request, the group managing unit 104 of the OLT 1 determines a multicast group including the ONU (#1) 2 corresponding to the request source BBU 3 and the ONU (#2) 2 based on the terminal management table 181. For example, the group managing unit 104 determines the multicast group by retrieving the ONU-IDs “#1” and “#2” corresponding to the common terminal ID “Tn” from the terminal management table 181 indicated by the reference symbol Gb in FIG. 9.

As illustrated in FIG. 7, the group managing unit 104 registers the multicast group of the ONU (#1) 2 and the ONU (#2) 2 in the group management table 182. In addition, the transfer setting unit 103 sets the terminal ID “Tn” in the respective transfer processing units 281 of the ONU (#1) 2 and the ONU (#2) 2 based on the group management table 182.

The transfer setting unit 103 of the OLT 1 makes a transfer setting in each of the transfer processing units 281 so that down frames Fd addressed to the mobile terminal Tn located at the cell edge are transferred from the reception processing unit 250 to the transmitter 291 in the ONU (#1) 2 and the ONU (#2) 2.

A reference symbol Ge in FIG. 10 indicates the respective transfer tables 240 of the ONU (#1) 2, the ONU (#2) 2, and the ONU (#3) 2. As indicated by dotted line circles, the common terminal ID “Tn” is registered in the respective transfer tables 240 of the ONU (#1) 2 and the ONU (#2) 2. The mobile terminal Tn may therefore receive the down frames Fd addressed to the own device from the OLT 1 via the ONU (#1) 2 and the ONU (#2) 2.

On the other hand, the transfer processing units 281 of the other ONUs (#3 to #n) 2 do not have the terminal ID “Tn” set therein, and thus discard the down frames Fd addressed to the mobile terminal Tn (see cross marks).

Thus, when the mobile terminal Tn is located at the cell edge, the OLT 1 responds to the multicast request from the BBU 3, and transmits down frames Fd to the plurality of ONUs 2 including the ONU 2 corresponding to the BBU 3 by multicast.

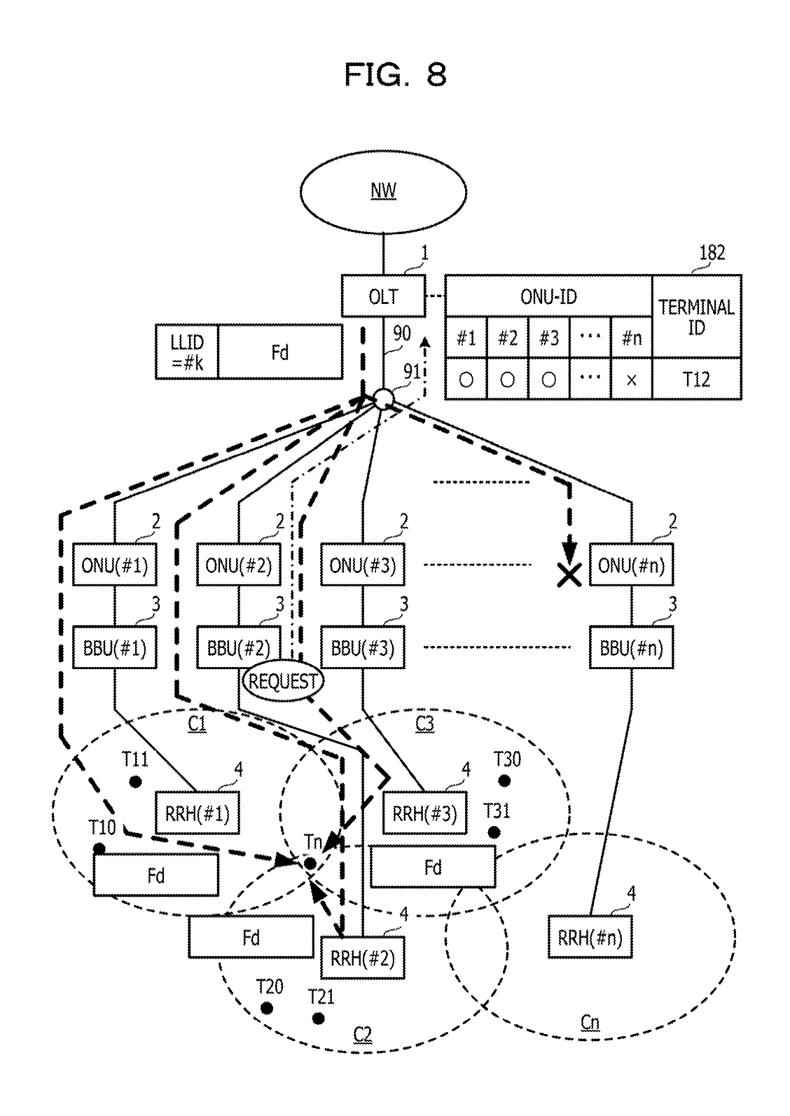

FIG. 8 is a diagram illustrating another example of multicast transmission. In FIG. 8, configurations common to FIG. 1 are identified by the same reference symbols, and description thereof will be omitted. Incidentally, thick dotted lines represent paths of a down frame Fd addressed to the mobile terminal Tn.

The mobile terminal Tn has moved from a position in FIG. 7 to a cell edge overlapping the cells C2 and C3.

A reference symbol Gc in FIG. 9 indicates the terminal management table 181 in the present example. As indicated by dotted line circles, the mobile terminal Tn is associated with the ONU (#1) 2, the ONU (#2) 2, and the ONU (#3) 2 as the mobile terminal Tn moves. At this time, as described above, the OLT 1 does not give an instruction for transfer processing to the transfer processing unit 281 of the ONU (#3) 2 until receiving a multicast request so that an error or unnecessary traffic does not occur.

Referring to FIG. 8 again, the BBU (#2) 3 of the cell C2 (or the BBU (#1) 3 of the cell C1) determines, for example, based on an SN ratio, that the mobile terminal Tn is located at a cell edge and that CoMP communication is accordingly desired, and transmits an up frame Fu including a multicast request to the OLT 1 (see alternate long and short dashed lines). Incidentally, the multicast request indicates the terminal ID “Tn” of the mobile terminal Tn as a CoMP target.

In response to the multicast request, the group managing unit 104 of the OLT 1 determines a multicast group including the ONU (#2) 2 corresponding to the request source BBU 3, the ONU (#1) 2, and the ONU (#3) 2 based on the terminal management table 181. For example, the group managing unit 104 determines the multicast group by retrieving the ONU-IDs “#1,” “#2,” and “#3” corresponding to the common terminal ID “Tn” from the terminal management table 181 indicated by the reference symbol Gb in FIG. 9.

As illustrated in FIG. 8, the group managing unit 104 registers the multicast group of the ONU (#1) 2, the ONU (#2) 2, and the ONU (#3) 2 in the group management table 182. In addition, the transfer setting unit 103 of the OLT 1 sets the terminal ID “Tn” in the respective transfer processing units 281 of the ONU (#1) 2, the ONU (#) 2, and the ONU (#3) 2 based on the group management table 182.

The transfer setting unit 103 of the OLT 1 makes a transfer setting in each of the transfer processing units 281 so that down frames Fd addressed to the mobile terminal Tn located at the cell edge are transferred from the reception processing unit 250 to the transmitter 291 in the ONU (#1) 2, the ONU (#2), and the ONU (#3) 2.

A reference symbol Gf in FIG. 10 indicates the respective transfer tables 240 of the ONU (#1) 2, the ONU (#2) 2, and the ONU (#3) 2. As indicated by dotted line circles, the common terminal ID “Tn” is registered in the respective transfer tables 240 of the ONU (#1) 2, the ONU (#2) 2, and the ONU (#3) 2. The mobile terminal Tn may therefore receive the down frames Fd addressed to the own device from the OLT 1 via the ONU (#1) 2, the ONU (#2) 2, and the ONU (#3) 2.

On the other hand, the transfer processing units 281 of the other ONUs (#4 to #n) 2 do not have the terminal ID “Tn” set therein and therefore discard the down frames Fd addressed to the mobile terminal Tn (see cross marks).

Thus, when the mobile terminal Tn moves, the OLT 1 may quickly change the multicast group by changing transfer settings in the transfer processing units 281 in response to the multicast request from the BBU 3 without making a setting change of the LLID.

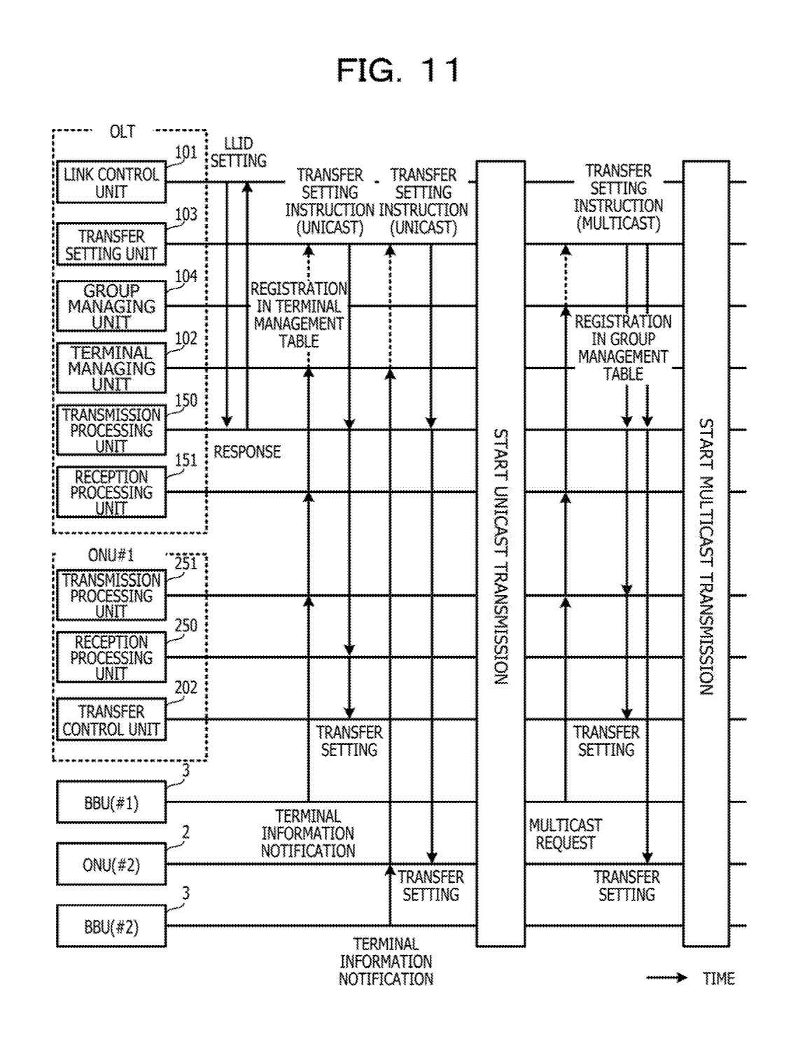

FIG. 11 is a sequence diagram illustrating communication processing between the OLT 1 and ONUs 2 in the first embodiment. The present example corresponds to the respective examples of the unicast transmission in FIG. 6 and the multicast transmission in FIG. 7.

In the OLT 1, the link control unit 101 sets the transmission processing unit 150 to add the broadcast LLID to down frames Fd. When the transmission processing unit 150 completes the setting, the transmission processing unit 150 outputs a response to the link control unit 101. Incidentally, the setting of the broadcast LLID is not needed after being once made until the OLT 1 is started again.

Next, the BBU (#1) 3 transmits an up frame Fu including terminal information to the OLT 1. The up frame Fu is input to the terminal managing unit 102 via the transmission processing unit 251 of the ONU (#1) 2 and the reception processing unit 151 of the OLT 1. The terminal managing unit 102 registers terminal IDs in the terminal management table 181 based on the terminal information. The terminal managing unit 102 notifies the registration of the terminal IDs to the transfer setting unit 103.

Next, when the transfer setting unit 103 receives the notification, the transfer setting unit 103 generates a control message for giving an instruction for a transfer setting in the transfer processing unit 281 and outputs the control message to the transmission processing unit 150 in order to perform unicast transmission to the ONU (#1) 2. The transmission processing unit 150 generates a control frame including the control message, and transmits the control frame to the ONU (#1) 2.

In the ONU (#1) 2, the reception processing unit 250 detects the control frame addressed to the own device based on a DA, for example, obtains the control message from the control frame, and outputs the control message to the transfer control unit 202. The transfer control unit 202 makes a transfer setting in the transfer processing unit 281 according to the transfer setting instruction within the control message.

In addition, also for the ONU (#2) 2, the OLT 1 makes a transfer setting in the transfer processing unit 281 by a procedure similar to the foregoing. Thereafter, the OLT 1 starts unicast transmission to the ONU (#1) 2 and the ONU (#2) 2 each.

When the mobile terminal Tn moves to the position in FIG. 7, the BBU (#1) 3 determines the necessity of CoMP communication based on a condition such as an SN ratio. When CoMP communication is to be performed, the BBU (#1) 3 transmits an up frame Fu including a multicast request to the OLT 1.

The up frame Fu is input to the reception processing unit 151 of the OLT 1 via the transmission processing unit 251 of the ONU (#1) 2. The reception processing unit 151 detects the multicast request from the up frame Fu by a given identifier, and outputs the multicast request to the group managing unit 104.

The group managing unit 104 determines a multicast group based on the terminal management table 181 in response to the multicast request, and registers the multicast group in the group management table 182. The group managing unit 104 notifies the registration of the multicast group to the transfer setting unit 103.

When the transfer setting unit 103 receives the notification, the transfer setting unit 103 generates a control message for giving an instruction for a transfer setting in the respective transfer processing units 281 of the ONU (#1) 2 and the ONU (#2) 2 and outputs the control message to the transmission processing unit 150 in order to perform multicast transmission to the ONU (#1) 2 and the ONU (#2) 2. The transmission processing unit 150 generates a control frame including the control message, and transmits the control frame to the ONU (#1) 2 and the ONU (#2) 2.

In the ONU (#1) 2, the reception processing unit 250 detects the control frame addressed to the own device based on a DA, for example, obtains the control message from the control frame, and outputs the control message to the transfer control unit 202. The transfer control unit 202 makes the transfer setting in the transfer processing unit 281 according to the transfer setting instruction within the control message. In addition, as in the ONU (#1) 2, the transfer control unit 202 of the ONU (#2) 2 also makes the transfer setting in the transfer processing unit 281 according to the transfer setting instruction within the control message. The OLT 1 thereafter starts multicast transmission to the ONU (#1) 2 and the ONU (#2) 2.

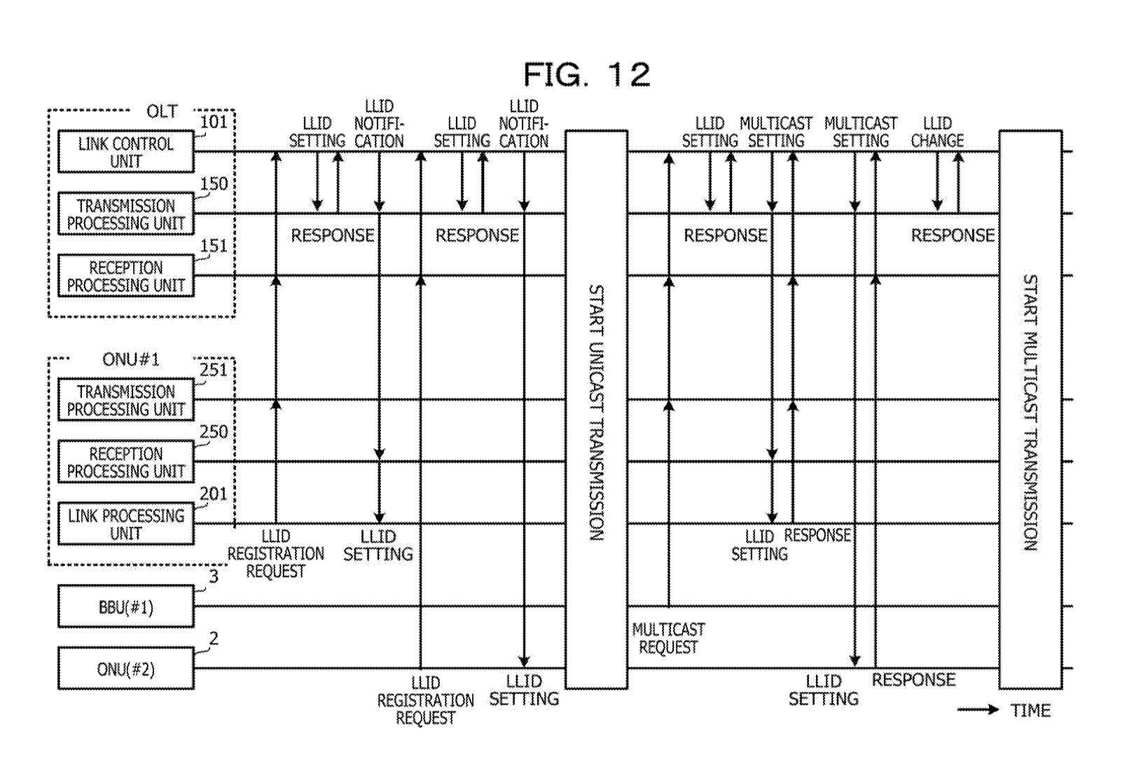

FIG. 12 is a sequence diagram illustrating communication processing between the OLT 1 and ONUs 2 in the comparative example. The present example corresponds to the respective examples of the unicast transmission in FIG. 6 and the multicast transmission in FIG. 7.

In the ONU (#1) 2, the link processing unit 201 generates a control message requesting registration of an individual LLID, and outputs the control message to the transmission processing unit 251. The transmission processing unit 251 generates a control frame including the control message, and transmits the control frame to the OLT 1.

In the OLT 1, the reception processing unit 151 receives the control frame, obtains the control message from the control frame, and outputs the control message to the link control unit 101. The link control unit 101 sets the LLID of the ONU (#1) 2 in the transmission processing unit 150. When the setting is completed, the transmission processing unit 150 outputs a response to the link control unit 101.

Next, the link control unit 101 generates a control message notifying the LLID, and outputs the control message to the transmission processing unit 150. The transmission processing unit 150 generates a control frame including the control message, and transmits the control frame to the ONU (#1) 2.

In the ONU (#1) 2, the reception processing unit 250 detects the control frame addressed to the own device based on a DA, for example, obtains the control message from the control frame, and outputs the control message to the link processing unit 201. The link processing unit 201 sets the LLID according to the notification of the LLID within the control message.

The OLT 1 also assigns an LLID to the ONU (#2) 2 by a procedure similar to the foregoing. The OLT 1 thereafter starts unicast transmission to the GNU (#1) 2 and the ONU (#2) 2 each.

When CoMP communication is to be performed due to movement of the mobile terminal Tn, the BBU (#1) 3 transmits an up frame Fu including a multicast request to the OLT 1. The up frame Fu is input to the reception processing unit 151 of the OLT 1 via the transmission processing unit 251 of the GNU (#1) 2. The reception processing unit 151 detects the multicast request from the up frame Fu by a given identifier, and outputs the multicast request to the link control unit 101.

The link control unit 101 determines a multicast group of the ONU (#1) 2 and the GNU (#2) 2 in response to the multicast request, and sets a common LLID within the multicast group to the transmission processing unit 150. When the setting is completed, the transmission processing unit 150 outputs a response to the link control unit 101.

Next, the link control unit 101 generates a control message notifying the multicast LLID, and outputs the control, message to the transmission processing unit 150. The transmission processing unit 150 generates a control frame including the control message, and transmits the control frame to the GNU (#1) 2.

In the GNU (#1) 2, the reception processing unit 250 detects the control frame addressed to the own device based on a DA, for example, obtains the control message from the control frame, and outputs the control message to the link processing unit 201. The link processing unit 201 sets the LLID according to the notification of the LLID within the control message. The OLT 1 also assigns the LLID for multicast transmission to the ONU (#2) 2 by a procedure similar to the foregoing.

Next, in the OLT 1, the link control unit 101 makes a setting in the transmission processing unit 150 so as to change the LLID of down frames Fd addressed to the mobile terminal Tn from the LLID for unicast transmission (individual LLID) to the LLID for multicast transmission. When the setting is completed, the transmission processing unit 150 outputs a response to the link control unit 101. The OLT 1 thereafter starts multicast transmission to the ONU (#1) 2 and the ONU (#2) 2.

Thus, in the comparative example, LLID setting processing for the transmission processing unit 150 is performed a plurality of times, so that much time is needed to change the multicast group. On the other hand, in the first embodiment, although the broadcast LLID is set first, the LLID setting processing is not needed at a time of changing the multicast group, so that a time taken for the changing processing is shortened as compared with the comparative example.

Description will next be made of respective pieces of processing of the OLT 1 and an ONU 2.

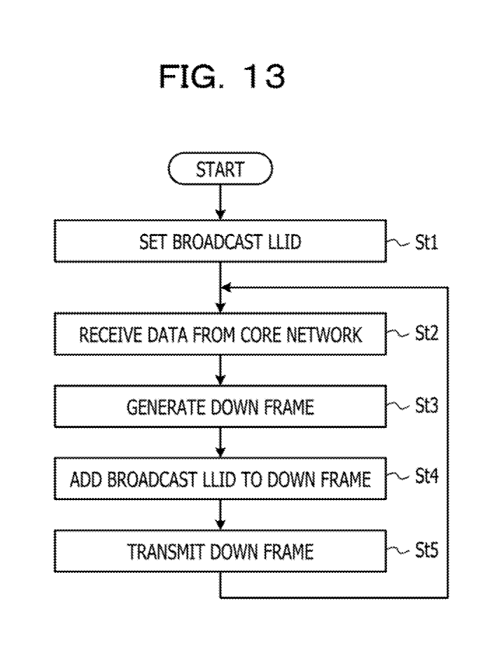

FIG. 13 is a flowchart illustrating an example of transmission processing of a down frame Fd by the OLT 1. The link control unit 101 sets the broadcast LLID in the transmission processing unit 150 (step St1). Next, the NW-IF 14 receives data from the core network NW (step St2), and generates a down frame Fd from the data (step St3).

Next, the transmission processing unit 150 adds the broadcast LLID to the down frame Fd (step St4). The transmission processing unit 150 next transmits the down frame Fd (step St5). Thereafter, each of the pieces of processing from step St2 on down is performed again. The OLT 1 thus performs the transmission processing of the down frame Fd.

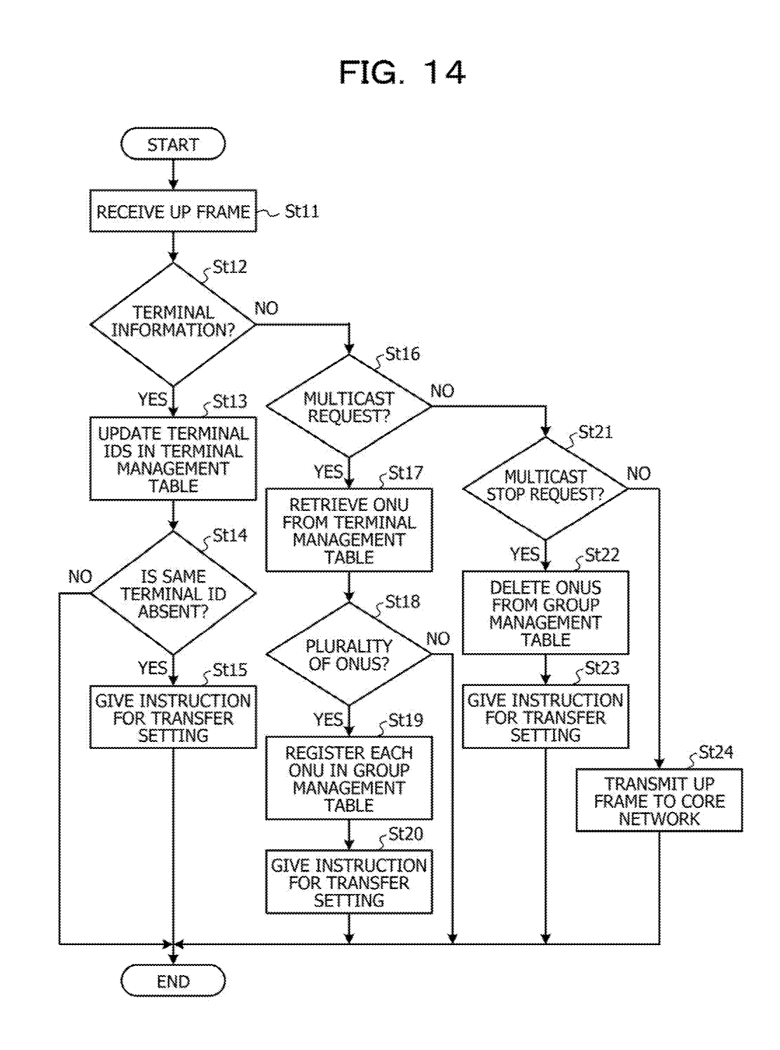

FIG. 14 is a flowchart illustrating an example of reception processing of an up frame Fu by the OLT 1. The reception processing unit 151 receives an up frame Fu from an ONU 2 (step St11). The reception processing unit 151 determines based on a given identifier whether or not terminal information is included in the up frame Fu (step St12).

When terminal information is included (Yes in step St12), the terminal managing unit 102 updates terminal IDs in the terminal management table 181 based on the terminal information (step St13). Next, the transfer setting unit 103 determines whether or not a same terminal ID as a terminal ID included in the terminal information is registered in the terminal management table 181 (step St14).

When the same terminal ID is not registered (Yes in step St14), the transfer setting unit 103 gives an instruction for a transfer setting in the transfer processing unit 281 of the ONU 2 corresponding to the terminal ID (step St15). Down frames Fd addressed to the mobile terminal Tx having the terminal ID are thereby transmitted from the OLT 1 to the ONU 2 by unicast.

In addition, when the same terminal ID is registered (No in step St14), the transfer setting unit 103 ends the processing without making a transfer setting.

In addition, when no terminal information is included (No in step St12), the reception processing unit 151 determines based on a given identifier whether or not a multicast request is included in the up frame Fu (step St16). When a multicast request is included (Yes in step St16), the group managing unit 104 retrieves an ONU 2 (ONU-ID) corresponding to a terminal ID indicated by the multicast request from the terminal management table 181 (step St17).

The group managing unit 104 determines whether or not a plurality of ONUs 2 are retrieved (step St18). When a plurality of ONUs 2 are retrieved (Yes in step St18), the group managing unit 104 registers each of the ONUs 2 in the group management table 182 (step St19). Next, the transfer setting unit 103 gives an instruction for a transfer setting in the transfer processing units 281 of the corresponding ONUs 2 (step St20). In addition, when a single ONU 2 is retrieved (No in step St18), the group managing unit 104 ends the processing without registering the ONU 2.

In addition, when no multicast request is included (No in step St16), the reception processing unit 151 determines based on a given identifier whether or not a multicast stop request is included in the up frame Fu (step St21). A BBU 3 transmits the multicast stop request to the OLT 1 to stop multicast transmission when CoMP communication becomes unnecessary due to movement of the mobile terminal Tx.

When a multicast stop request is included (Yes in step St21), the group managing unit 104 deletes corresponding ONUs 2 from the group management table 182 (step St22). Next, the transfer setting unit 103 gives an instruction for a transfer setting in the transfer processing units 281 of the corresponding ONUs 2 (step St23).

In addition, when no multicast stop request is included (No in step St21), the reception processing unit 151 transmits the up frame Fu to the core network NW via the NW-IF 14 (step St24). The OLT 1 thus performs the reception processing of the up frame Fu.

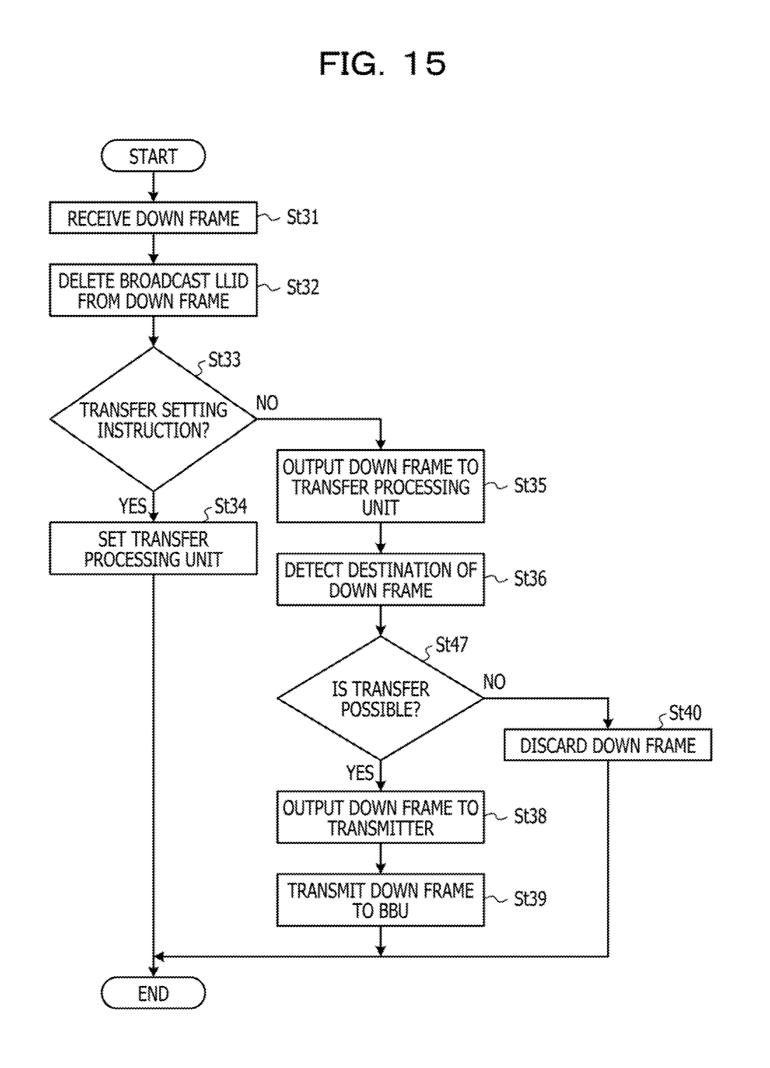

FIG. 15 is a flowchart illustrating an example of reception processing of a down frame Fd by an ONU 2. The reception processing unit 250 receives a down frame Fd from the OLT 1 (step St 1). Because the broadcast LLID is added to down frames Fd, the reception processing unit 250 receives all of the down frames Fd. The reception processing unit 250 next deletes the broadcast LLID from the down frame Fd (step St32).

Next, the reception processing unit 250 determines based on a given identifier whether or not a control message of a transfer setting instruction is included in the down frame Fd (step St33). When a control message of a transfer setting instruction is included (Yes in step St33), the transfer control unit 202 updates the transfer table 240 and sets the transfer processing unit 281 according to the instruction (step St34).

In addition, when no control message of a transfer setting instruction is included (No in step St33), the reception processing unit 250 outputs the down frame Fd to the transfer processing unit 281 (step St35). Next, the transfer processing unit 281 detects the destination of the down frame Fd (step St36).

The transfer processing unit 281 determines whether the down frame Fd may be transferred to the transmitter 291 based on the destination (step St37). For example, the transfer processing unit 281 determines whether or not the destination corresponds to a terminal ID specified by a transfer setting from the OLT 1.

When the down frame Fd may be transferred (Yes in step St37), the transfer processing unit 281 transfers the down frame Fd to the transmitter 291 (step St38). Next, the transmitter 291 transmits the down frame Fd to the BBU 3 (step St39).

In addition, when it is difficult to transfer the down frame Fd (No in step St37), the transfer processing unit 281 discards the down frame Fd (step St40). The ONU 2 thus performs the reception processing of the down frame Fd. Incidentally, each of the above-described pieces of processing is an example of a transmitting method.

### Second Embodiment

In the first embodiment, the OLT 1 uses the broadcast LLID. However, the OLT 1 may use LLIDs for multicast transmission which LLIDs are already set in advance. In this case, it suffices for the OLT 1 to change an LLID to be added in response to a multicast request from a BBU 3, and thus the OLT 1 may save the trouble of making a multicast setting in ONUs 2. It is therefore possible to change a multicast group quickly according to movement of the mobile terminal Tx. The following description will be made mainly of differences from the first embodiment.

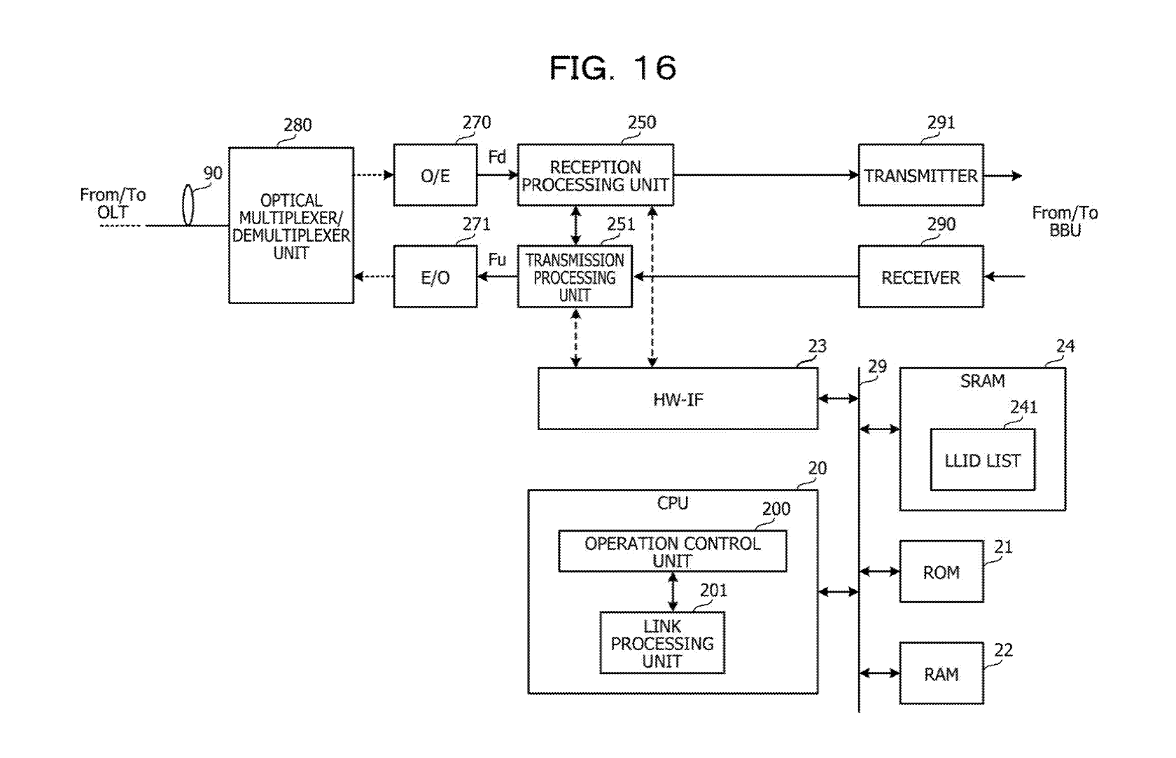

FIG. 16 is a block diagram illustrating an ONU 2 according to a second embodiment. In FIG. 16, configurations common to FIG. 3 are identified by the same reference symbols, and description thereof will be omitted.

The ONU 2 includes a CPU 20, a ROM 21, a RAM 22, an HW-IF 23, and an SRAM 24. The ONU 2 also includes an optical multiplexer/demultiplexer unit 280, an optical-to-electrical converting unit (O/E) 270, an electrical-to-optical converting unit (E/O) 271, a reception processing unit 250, a transmission processing unit 251, a receiver 290, and a transmitter 291.

The reception processing unit 250 is an example of a receiving unit. The reception processing unit 250 receives a down frame Fd to which an LLID is added via an optical fiber 90. For example, the reception processing unit 250 receives a down frame Fd provided with an individual LLID of the own ONU 2, the individual LLID being assigned from the OLT 1, a broadcast LLID, or the LLID of a multicast group, and discards down frames Fd to which other LLIDs are added.

The transmitter 291 is an example of a third transmitting unit. The transmitter 291 transmits the down frame Fd received by the reception processing unit 250 to a BBU 3 and an RRH 4 communicating with one or more mobile terminals Tx.

The SRAM 24 stores an LLID list 241 in which the LLIDs of down frames Fd to be received in the reception processing unit 250 are registered. The LLIDs are registered into the LLID list 241 from the CPU 20.

When the CPU 20 reads a program from the ROM 21, an operation control unit 200 and a link processing unit 201 are formed as functions. The link processing unit 201 registers LLIDs in the LLID list 241 according to the notification of the LLIDs from the OLT 1. The link processing unit 201 sets the reception processing unit 250 to receive down frames Fd to which the LLIDs registered in the LLID list 241 are added.

The OLT 1 sets, in advance, an LLID for multicast transmission in each ONU 2 of a corresponding multicast group. Therefore, the LLID for multicast transmission is registered in the LLID list 241. Incidentally, a sequence of setting the LLID for multicast transmission is as illustrated in FIG. 12, for example.

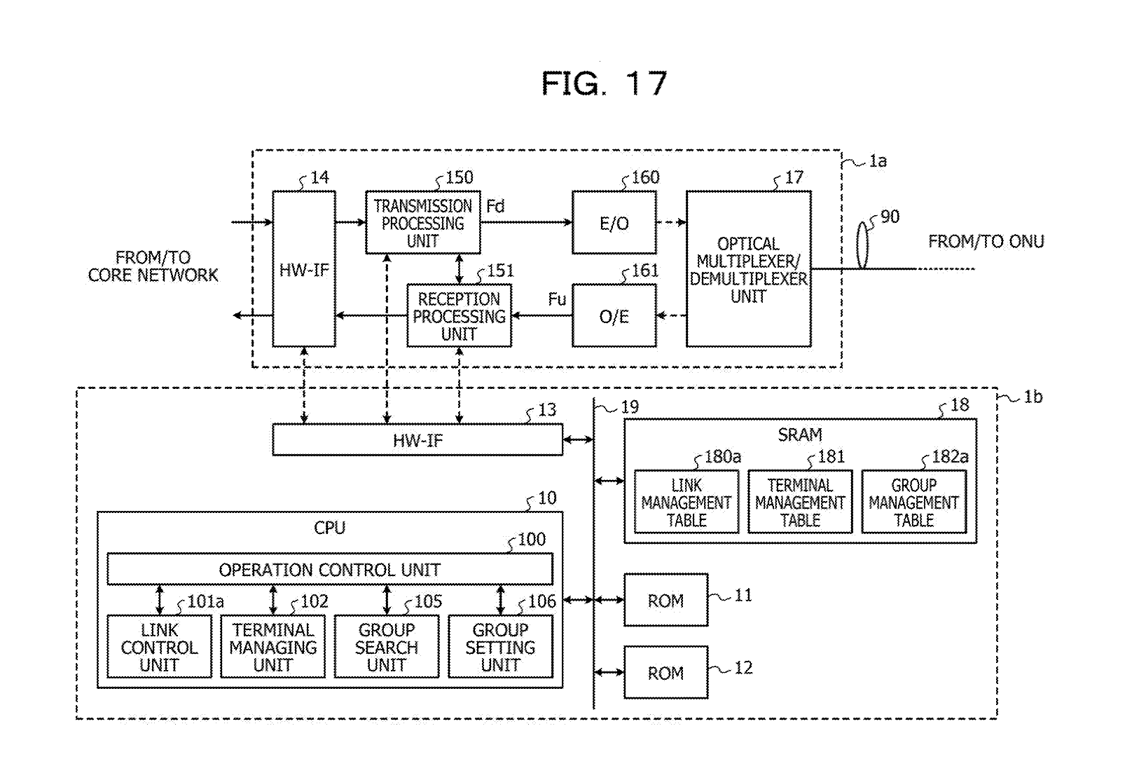

FIG. 17 is a block diagram illustrating the OLT 1 according to the second embodiment. In FIG. 17, configurations common to FIG. 4 are identified by the same reference symbols, and description thereof will be omitted. The OLT 1 includes an optical interface unit 1a and a control unit 1b.

The optical interface unit 1a includes an NW-IF 14, an optical multiplexer/demultiplexer unit 17, a transmission processing unit 150, a reception processing unit 151, an electrical-to-optical converting unit (E/O) 160, and an optical-to-electrical converting unit (O/E) 161. The control unit 1b includes a CPU 10, a ROM 11, a RAM 12, an HW-IF 13, and an SRAM 18.

The transmission processing unit 150 is an example of a fourth transmitting unit. The transmission processing unit 150 adds LLIDs corresponding to mobile terminals Tx as the destinations of down frames Fd to the frames, and transmits the down frames Fd to respective ONUs 2. As described above, the ONUs 2 each receive only the down frames Fd having the LLIDs registered in the LLID list 241. Incidentally, the LLIDs added by the transmission processing unit 251 are set by a link control unit 101a.

The SRAM 18 stores a link management table 180a, a terminal management table 181, and a group management table 182a. Incidentally, the SRAM 18 is an example of a storage unit that stores the group management table 182a.

When the CPU 10 reads a program from the ROM 11, the following are formed as functions: an operation control unit 100, a link control unit 101a, a terminal managing unit 102, a group search unit 105, and a group setting unit 106. The operation control unit 100 controls operation of the whole of the OLT 1, and gives instructions for operation to the link control unit 101a, the terminal managing unit 102, the group search unit 105, and the group setting unit 106 according to a given sequence. Incidentally, the operation control unit 100, the link control unit 101a, the terminal managing unit 102, the group search unit 105, and the group setting unit 106 may, for example, include a logic circuit such as an FPGA or an ASIC.

The link control unit 101a establishes links to ONUs 2 by transmitting and receiving given control messages to and from the ONUs 2. The link control unit 101a registers LLIDs used between the OLT 1 and the ONUs 2 to which the links are established in the link management table 180a, and sets the LLIDs in the transmission processing unit 150 and the reception processing unit 151 based on the link management table 180a. The LLIDs include the individual LLIDs of the respective ONUs 2 and the LLIDs of respective multicast groups.

In response to a multicast request from a BBU 3, the group search unit 105 retrieves a plurality of ONUs 2 corresponding to a terminal ID indicated in the multicast request from the terminal management table 181, and retrieves the LLID of a multicast group to which the plurality of ONUs 2 belong from the group management table 182a.

The group search unit 105 is an example of a search unit, and retrieves the LLID corresponding to the multicast group corresponding to the request source BBU 3 from the group management table in response to the request from the BBU 3. The group search unit 105 notifies the LLID of the multicast group to the link control unit 101a. Incidentally, the multicast group is an example of a group to which two or more ONUs 2 belong.

In response to the notification, the link control unit 101a changes the LLID of down frames Fd addressed to a mobile terminal Tx having the terminal ID indicated in the multicast request from an individual LLID to the LLID of the multicast group.

The group setting unit 106 sets multicast groups in advance based on the arrangement of the cells C1 to Cn or the like. The group setting unit 106 registers, in the group management table 182a, correspondence relations between pluralities of ONUs 2 belonging to the multicast groups and LLIDs.

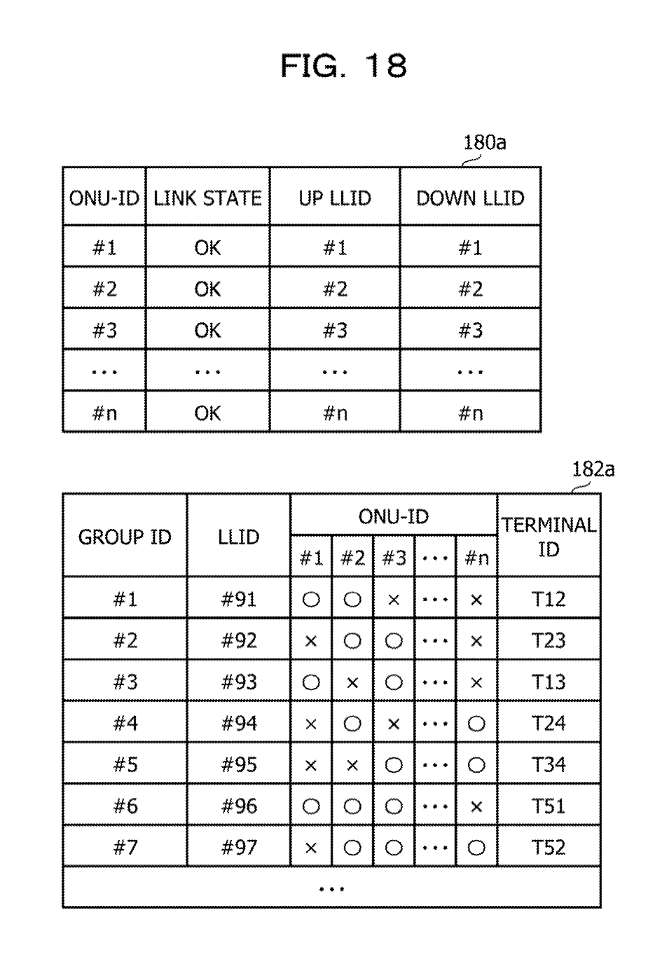

FIG. 18 is a diagram illustrating an example of the link management table 180a and the group management table 182a. Registered in the link management table 180a are ONU-IDs, link states, up LLIDs, and down LLIDs. Unlike the first embodiment, individual LLIDs rather than the broadcast LLID are registered as the down LLIDs. Therefore, when unicast transmission is performed, the transmission processing unit 150 adds the individual LLIDs to down frames Fd.

The group management table 182a includes a same configuration as that illustrated in FIG. 2. The group setting unit 106 sets, in advance, multicast groups to which pluralities of ONUs 2 belong from positional relations between the cells C1 to Cn, for example.

The group setting unit 105 registers, in the group management table 182a, a correspondence relation between the ONU-IDs of respective ONUs 2 of a multicast group and an LLID. For example, registered in the group management table 182a is a correspondence relation between a multicast group to which two or more ONUs 2 belong and a common LLID within the multicast group.

The group search unit 105 retrieves two or more ONU-IDs corresponding to a terminal ID indicated in a multicast request from the terminal management table 181, and retrieves the LLID of a multicast group corresponding to the two or more ONU-IDs from the group management table 182a. When the group search unit 105 retrieves the ONU-IDs “#1” and “#2” corresponding to the terminal ID “T12” from the terminal management table 181, for example, the group search unit 105 retrieves the LLID “#91” of the multicast group #1 from the group management table 182a.

In addition, the group search unit 105 registers the terminal ID “T12” in the group management table 182a in association with the multicast group #1. The link control unit 101a sets the transmission processing unit 150 to add the LLID “#91” of the multicast group #1 to down frames Fd addressed to the terminal ID “T12.”

Thus, the transmission processing unit 150 adds the LLID retrieved by the group search unit 105 to down frames Fd addressed to the common mobile terminal Tx within the multicast group, and transmits the down frames Fd to each of the plurality of ONUs 2. Therefore, each time the mobile terminal Tx moves, the OLT 1 may change the multicast group quickly by changing the LLID added to the down frames Fd addressed to the mobile terminal Tx.

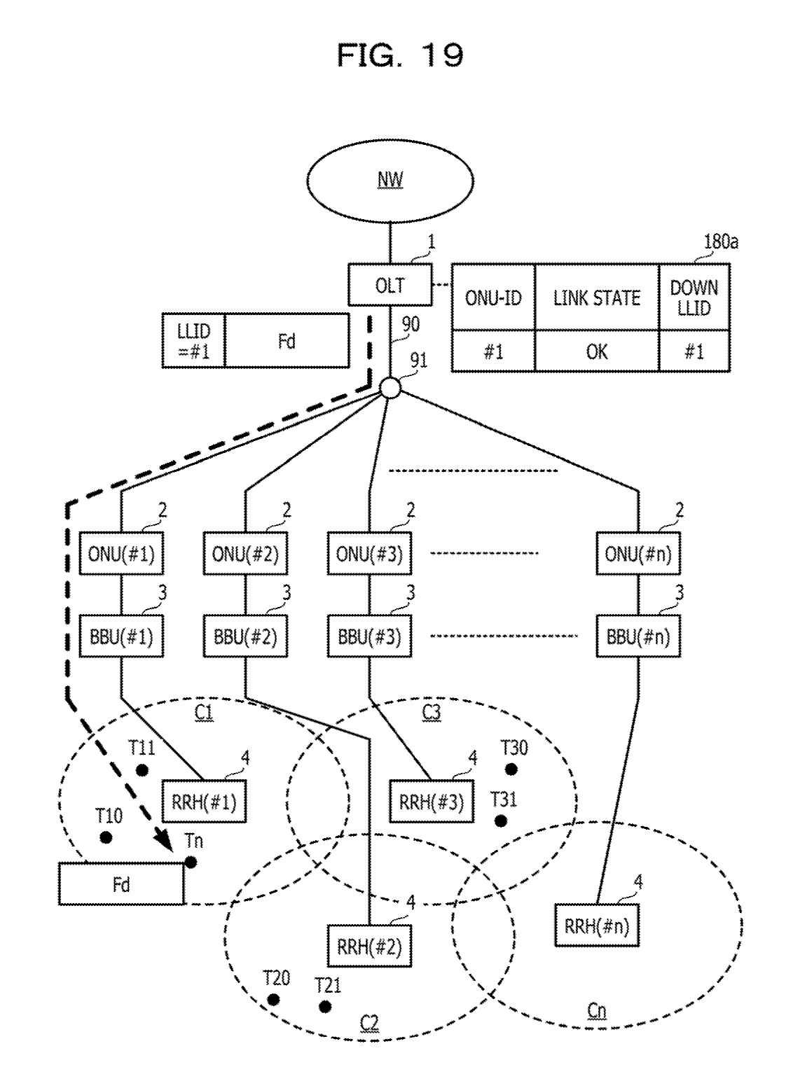

Next, referring to FIGS. 19 to 21, description will be made of examples of transmission of a down frame Fd by the OLT 1. FIGS. 19 to 21 each represent a case where mobile terminals T10, T11, Tn, T20, T21, T30, and T31 are present at the same positions as in FIGS. 6 to 8. Incidentally, in the following examples, description of same contents as in FIGS. 6 to 8 will be omitted.

FIG. 19 is a diagram illustrating an example of unicast transmission. The mobile terminal Tn is present within the cell C1 corresponding to the ONU (#1) 2. Thus, the OLT 1 adds the down LLID “#1” registered in the link management table 180a to a down frame Fd, and transmits the down frame Fd to the ONU (#1) 2 by unicast. The mobile terminal Tn therefore receives the down frame Fd from the OLT 1 via the ONU (#1) 2.

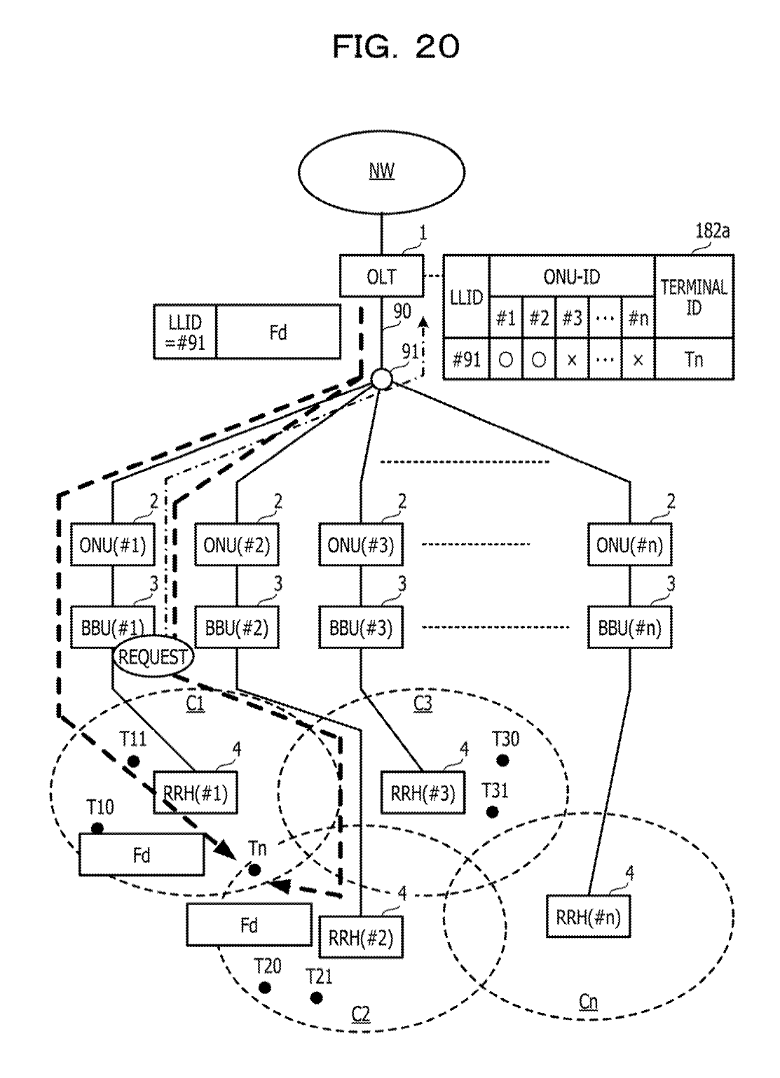

FIG. 20 is a diagram illustrating an example of multicast transmission. The mobile terminal Tn has moved to a cell edge overlapping the cell C2. Thus, the BBU (#1) 3 transmits a multicast request to the OLT 1 based on an SN ratio or the like (see alternate long and short dashed lines).

In response to the multicast request from the BBU (#1) 3, the group search unit 105 retrieves, from the group management table 182a, the LLID “#91” of the multicast group #1 of the ONU (#1) 2 and the ONU (#2) 2 corresponding to the terminal ID “Tn” indicated in the multicast request. The transmission processing unit 150 adds the LLID “#91” to a down frame Fd addressed to the mobile terminal Tx, and transmits the down frame Fd to the ONU (#1) 2 and the ONU (#2) 2 by multicast.

The LLID “#91” is set in the respective reception processing units 250 of the ONU (#1) 2 and the ONU (#2) 2 in advance. Thus, the mobile terminal Tn may receive the down frame Fd from the OLT 1 via the ONU (#1) 2 and the ONU (#2) 2.

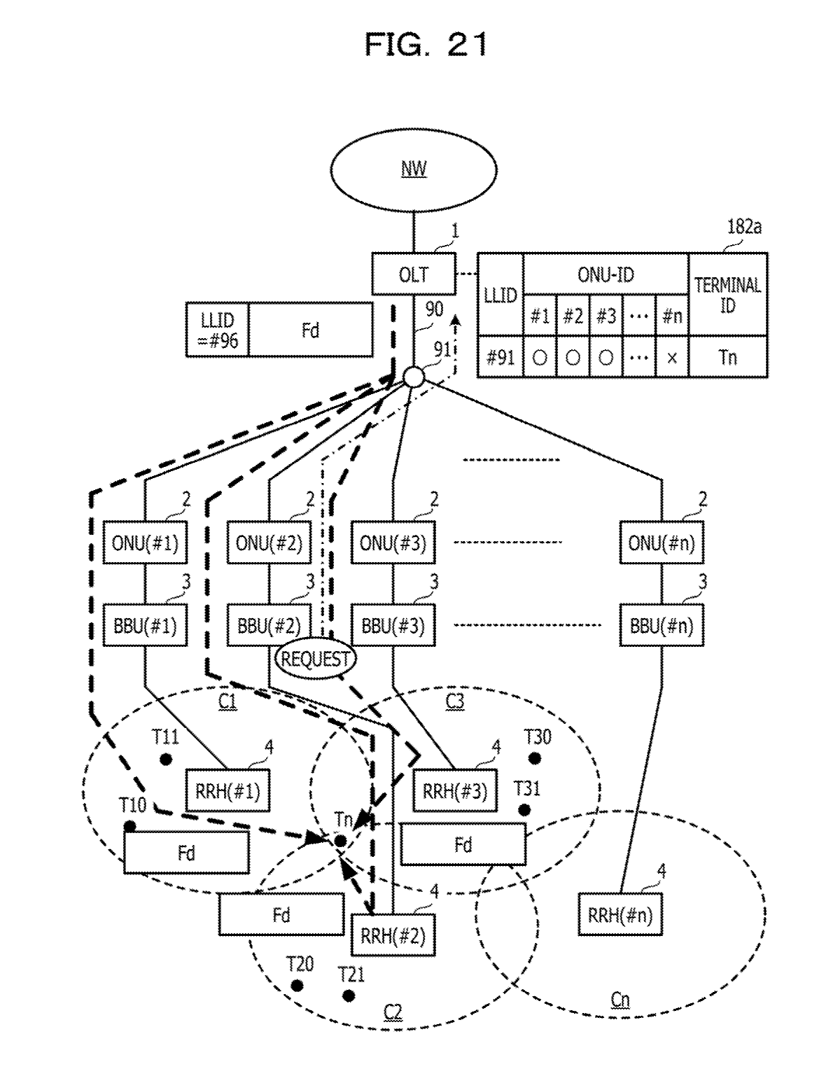

FIG. 21 is a diagram illustrating another example of multicast transmission. The mobile terminal Tn has moved to a cell edge overlapping the cells C2 and C3. The BBU (#2) 3 therefore transmits a multicast request to the OLT 1 based on an SN ratio or the like (see alternate long and short dashed lines).

In response to the multicast request from the BBU (#1) 3, the group search unit 105 retrieves, from the group management table 182a, the LLID “#96” of the multicast group #6 of the ONU (#1) 2, the ONU (#2) 2, and the ONU (#3) 2 corresponding to the terminal ID “Tn” indicated in the multicast request. The transmission processing unit 150 adds the LLID “#96” to a down frame Fd addressed to the mobile terminal Tx, and transmits the down frame Fd to the ONU (#1) 2, the ONU (#2) 2, and the ONU (#3) 2 by multicast.

The LLID “#96” is set in the respective reception processing units 250 of the ONU (#1) 2, the ONU (#2) 2, and the ONU (#3) 2 in advance. Thus, the mobile terminal Tn may receive the down frame Fd from the OLT 1 via the ONU (#1) 2, the ONU (#2) 2, and the ONU (#3) 2.

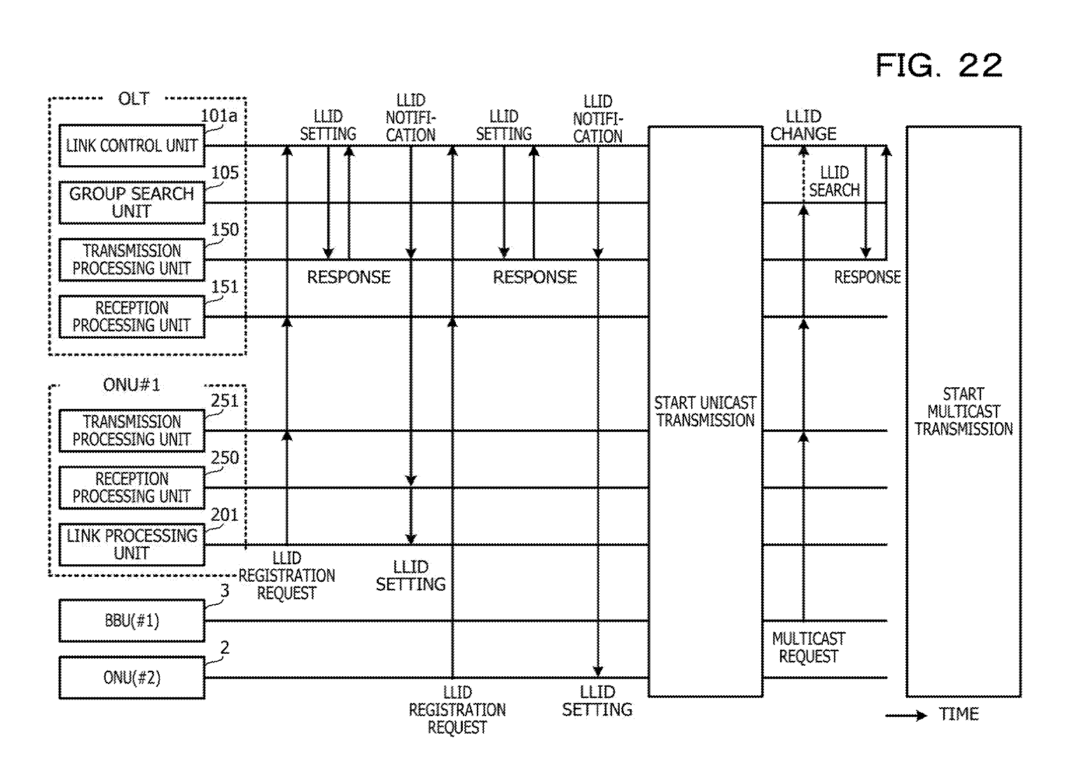

FIG. 22 is a sequence diagram illustrating communication processing between the OLT 1 and ONUs 2 in the second embodiment. The present example corresponds to the respective examples of the unicast transmission in FIG. 19 and the multicast transmission in FIG. 20. Incidentally, a sequence up to a start of unicast transmission is similar to that of FIG. 12, and therefore description thereof will be omitted.

The BBU (#1) includes a multicast request in an up frame Fu, and transmits the up frame Fu to the OLT 1, The reception processing unit 151 detects the multicast request from the up frame Fu based on a given identifier, and outputs the multicast request to the group search unit 105. The group search unit 105 retrieves the LLID of a multicast group in response to the multicast request from the group management table 182a, and notifies the LLID to the link control unit 101a.

The link control unit 101a sets the transmission processing unit 150 so as to change the LLID to be added to a down frame Fd addressed to the mobile terminal Tn from the individual LLID “#1” to the LLID “#91” for multicast transmission. When the setting is completed, the transmission processing unit 150 outputs a response to the link control unit 101a. The OLT 1 thereafter starts multicast transmission to the ONU (#1) 2 and the ONU (#2) 2.

Thus, in the first embodiment, the OLT 1 sets LLIDs for multicast transmission in each ONU 2 in advance. It is therefore possible to change the multicast group quickly by changing the LLID to be added to down frames Fd without making settings in the ONUs 2.

Description will next be made of respective pieces of processing of the OLT 1 and an ONU 2.

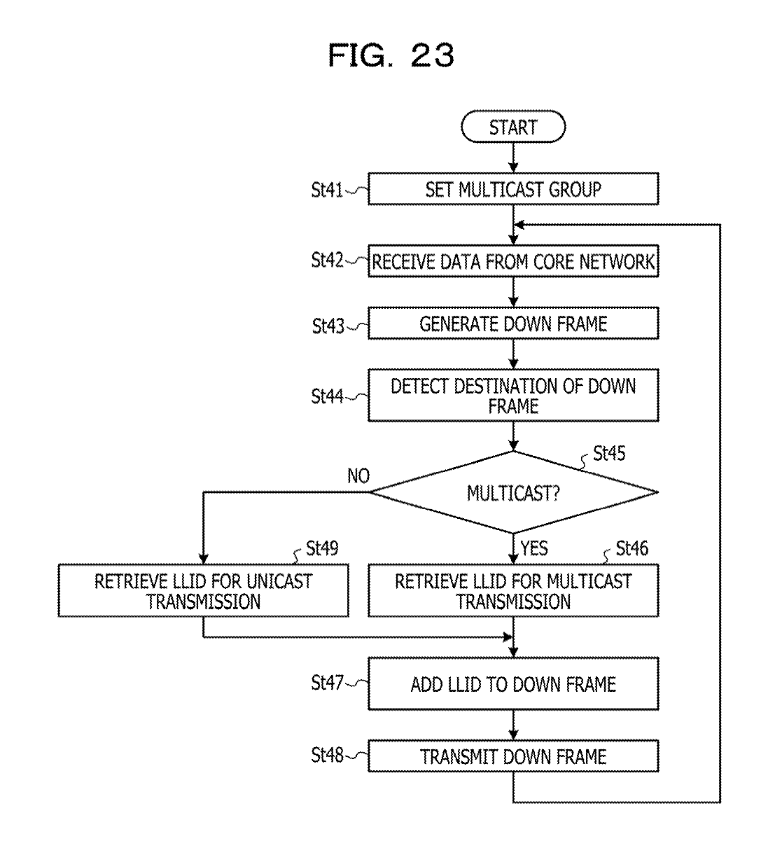

FIG. 23 is a flowchart illustrating an example of transmission processing of a down frame Fd by the OLT 1. The group setting unit 106 sets multicast groups based on positional relations between the cells C1 to Cn or the like (step St41). The group setting unit 106 registers the multicast groups in the group management table 182a.

Next, the NW-IF 14 receives data from the core network NW (step St42), and generates a down frame Fd (step St43). The down frame Fd is input to the transmission processing unit 150.

Next, the transmission processing unit 150 detects the destination of the down frame Fd (step St44). The transmission processing unit 150 next determines whether or not the destination is a target of multicast transmission based on LLID settings from the link control unit 101 (step St45).

When the destination is not a target of multicast transmission (No in step St45), the transmission processing unit 150 retrieves an LLID for unicast transmission (individual LLID of each ONU 2), the LLID corresponding to the destination, from the setting information of the link control unit 101 (step St49). In addition, when the destination is a target of multicast transmission (Yes in step St45), the transmission processing unit 150 retrieves an LLID for multicast transmission (LLID of a multicast group), the LLID corresponding to the destination, from the setting information of the link control unit 101 (step St46).

Next, the transmission processing unit 150 adds the retrieved LLID to the down frame Fd (step St47), and transmits the down frame Fd to each ONU 2 (step St48). Thereafter, each piece of processing from step St42 on down is performed again. The OLT 1 thus performs the transmission processing of the down frame Fd.

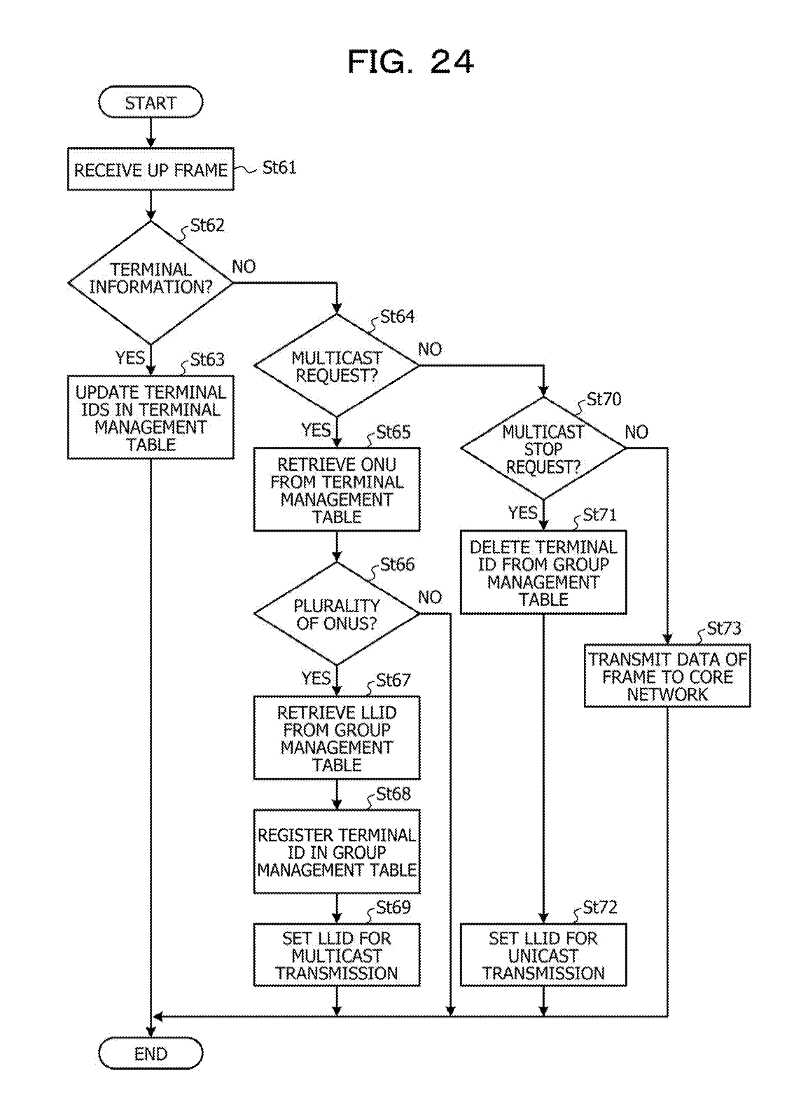

FIG. 24 is a flowchart illustrating an example of reception processing of an up frame Fu by the OLT 1. The reception processing unit 151 receives an up frame Fu from an ONU 2 (step St61). The reception processing unit 151 determines based on a given identifier whether or not terminal information is included in the up frame Fu (step St62). When terminal information is included (Yes in step St62), the terminal managing unit 102 updates terminal IDs in the terminal management table 181 based on the terminal information (step St63).

In addition, when no terminal information is included (No in step St62), the reception processing unit 151 determines whether or not a multicast request is included in the up frame Fu based on a given identifier (step St64). When a multicast request is included (Yes in step St64), the group search unit 105 retrieves an ONU 2 (ONU-ID) corresponding to a terminal ID indicated by the multicast request from the terminal management table 181 (step St65).

The group search unit 105 determines whether or not a plurality of ONUs 2 are retrieved (step St66). When a plurality of ONUs 2 are retrieved (Yes in step St66), the group search unit 105 retrieves the LLID of a multicast group corresponding to each of the ONUs 2 from the group management table 182a (step St67).

Next, the group search unit 105 registers the terminal ID in the group management table 182a in association with the multicast group (step St68). Next, the link control unit 101a sets the LLID retrieved by the group search unit 105 as an LLID for multicast transmission, the LLID corresponding to the terminal ID indicated in the multicast request, in the transmission processing unit 150 (step st69). In addition, when a single ONU 2 is retrieved (No in step St66), the group search unit 105 ends the processing.

In addition, when no multicast request is included (No in step St64), the reception processing unit 151 determines based on a given identifier whether or not a multicast stop request is included in the up frame Fu (step St70). When a multicast stop request is included (Yes in step St70), the link control unit 101a deletes a terminal ID indicated in the multicast stop request from the group management table 182a (step St71). Next, the link control unit 101a sets the individual LLIDs of ONUs 2 corresponding to the terminal ID indicated in the multicast stop request as LLIDs for unicast transmission in the transmission processing unit 150 (step St72).

In addition, when no multicast stop request is included (No in step St70), the reception processing unit 151 transmits the up frame Fu to the core network NW via the NW-IF 14 (step St73). The OLT 1 thus performs the reception processing of the up frame Fu.

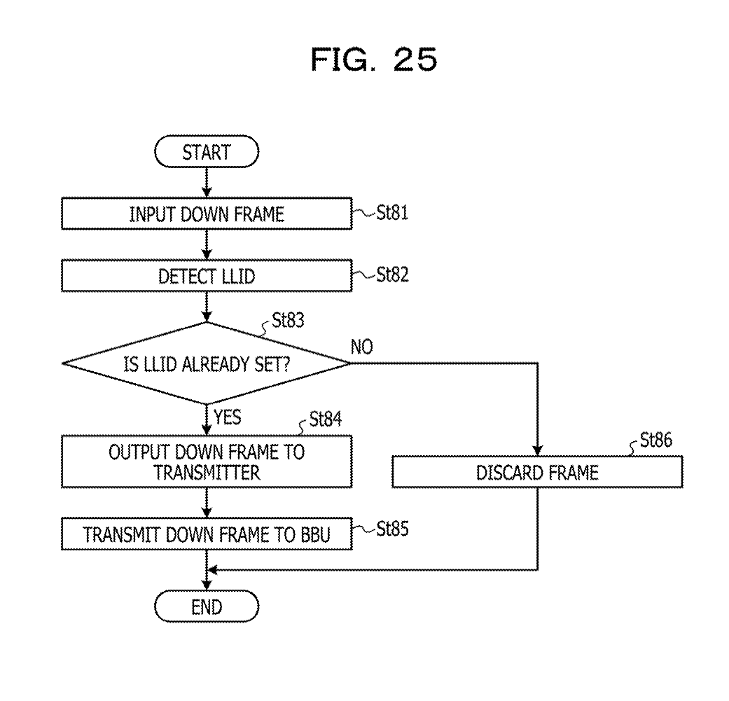

FIG. 25 is a flowchart illustrating an example of reception processing of a down frame Fd by an ONU 2. A down frame Fd is input from the OLT 1 to the reception processing unit 250 (step St81). Next, the reception processing unit 250 detects an LLID added to the down frame Fd (step St82).

The reception processing unit 250 determines whether or not the LLID is already set by the link processing unit 201 (step St83). When the LLID is already set (Yes in step St83), the reception processing unit 250 outputs the down frame Fd to the transmitter 291 (step St84). Next, the transmitter 291 transmits the down frame Fd to the BBU 3 (step St85).

In addition, when the LLID is not already set (No in step St83), the reception processing unit 250 discards the down frame Fd (step St86). The ONU 2 thus performs the reception processing of the down frame Fd.

(TWDM-PON)

The above-described OLT 1 may be applied to a TWDM-PON. The TWDM-PON is a PON capable of wavelength-multiplexing and transmitting optical signals of a plurality of wavelengths in an up direction and a down direction.

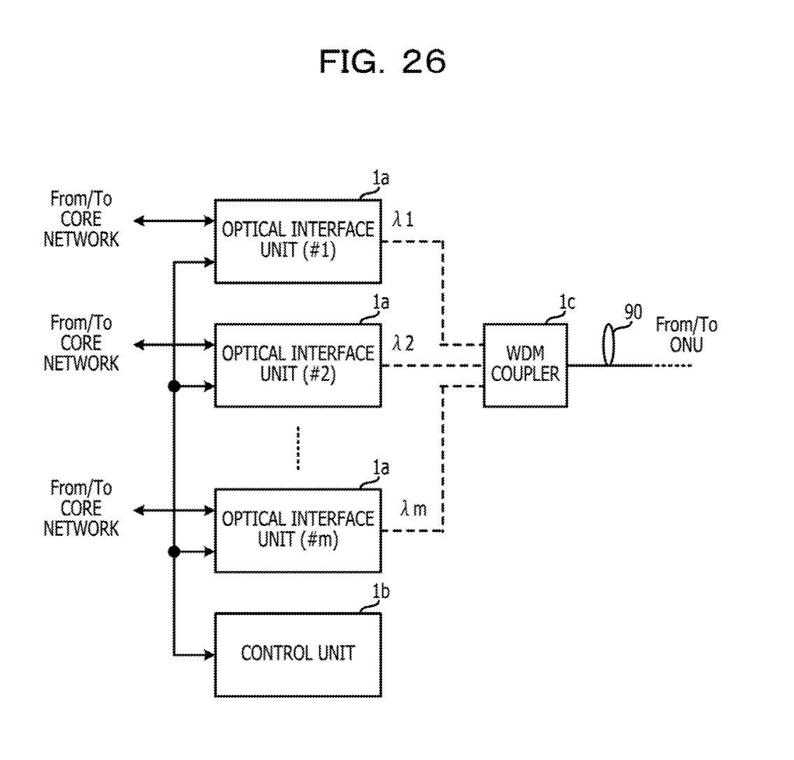

FIG. 26 is a block diagram illustrating an example of the OLT 1 of the TWDM-PON. The OLT 1 includes a plurality of optical interface units (#1 to #m (m: a positive integer)) 1a, a control unit 1b, and a WDM coupler 1c.

The optical interface units (#1 to #m) 1a transmit and receive optical signals of wavelengths λ1 to λm different from each other. For example, electrical-to-optical converting units 160 of the respective optical interface units (#1 to #m) 1a transmit optical signals of the wavelengths λ1 to λm, and optical-to-electrical converting units 161 of the respective optical interface units (#1 to #m) 1a receive optical signals of the wavelengths λ1 to λm.

The WDM coupler 1c couples an optical fiber 90 of a transmission line to each of the optical interface units (#1 to #m) la. The WDM coupler 1c guides optical signals of the wavelengths λ1 to λm, the optical signals being input from the optical fiber 90, to the optical interface units (#1 to #m) 1a, respectively. In addition, the WDM coupler 1c guides optical signals of the wavelengths λ1 to λm, the optical signals being input from the optical interface units (#1 to #m) 1a, respectively, to the optical fiber 90.

According to the TWDM-PON, optical signals of the plurality of wavelengths λ1 to λm are wavelength-multiplexed and transmitted between the OLT 1 and a plurality of ONUs 2, and therefore high-capacity data transmission may be realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system comprising:
a first optical communicating device; and
a plurality of second optical communicating devices coupled to the first optical communicating device through a plurality of optical transmission lines respectively, and coupled to a plurality of radio communicating devices respectively,
wherein
the first optical communicating device is configured to:
transmit a first frame to the plurality of second optical communicating devices; and
transmit an instruction to the plurality of second optical communicating devices respectively, the instruction instructs each of the plurality of second optical communicating devices that whether to transmit the first frame to a radio communicating device corresponding to each of the plurality of second optical communicating devices,
each of the plurality of second optical communicating devices is configured to:
receive the first frame and the instruction from the first optical communicating device;
control, based on the instruction, whether to transmit the received first frame to the radio communicating device; and
the first optical communicating device is configured to, based on a request from the radio communicating device, generates the instruction such that the first frame is to be transmitted to a mobile terminal device through two or more radio communicating devices.

2. The transmission system according to claim 1, wherein
the first optical communicating device is configured to add an identifier of a logical line commonly used among the plurality of second optical communicating devices to the first frame, and transmits the first frame to the plurality of second optical communicating devices, and
the second optical communicating device is configured to delete the identifier from the first frame.

3. The transmission system according to claim 1, wherein
the second optical communicating device is configured to transmit, to the first optical communicating device, a second frame including terminal information identifying the mobile terminal device, the terminal information is transmitted from the radio communicating device, and
the first optical communicating device is configured to generate the instruction based on the terminal information included in the second frame.

4. The transmission system according to claim 3, wherein
the second optical communicating device is configured to transmit a third frame including the request from the radio communicating device to the first optical communicating device.

5. The transmission system according to claim 3, wherein
the first optical communicating device includes:
a memory configured to store a terminal management table defining correspondence relation between each of the plurality of second optical communicating devices and the mobile terminal device based on the terminal information, and
a processor coupled to the memory and configured to identify two or more radio communicating devices coupled to the two or more second optical communicating devices respectively based on the terminal management table and the terminal information indicated in the request.

6. A transmission system comprising:
a first optical communicating device; and
a plurality of second optical communicating devices coupled to the first optical communicating device through a plurality of optical transmission lines respectively, and coupled to a plurality of radio communicating devices respectively,
wherein
the first optical communicating device is configured to transmit a frame to the plurality of second optical communicating devices respectively, and
each of the plurality of second optical communicating devices is configured to receive the frame from the first optical communicating device;
add, to the frame, an identifier of a logical line between a second optical communicating device corresponding to a mobile terminal device as a destination of the frame among the plurality of second optical communicating devices and the first optical communicating device;
execute grouping of the plurality of second optical communicating devices into a plurality of groups;
store a group management table defining, for each of the plurality of groups, correspondence relation between a group and an identifier of a common logical line within the group;
based on a request from a radio communicating device of the plurality of radio communicating devices, select the identifier of the common logical line within the group corresponding to the communicating device among the plurality of second optical communicating devices from the group management table;
add the selected identifier to the frame; and
transmit the frame to the plurality of second optical communicating devices.

7. A method of frame transmission using a transmission system including a first optical communicating device, and a plurality of second optical communicating devices coupled to the first optical communicating device through a plurality of optical transmission lines respectively, and coupled to a plurality of radio communicating devices respectively, the method comprising:
transmitting, from the first optical communicating device, a first frame to the plurality of second optical communicating devices;
transmitting, from the first optical communicating device, an instruction to the plurality of second optical communicating devices respectively, the instruction instructs each of the plurality of second optical communicating devices that whether to transmit the first frame to a radio communicating device corresponding to each of the plurality of second optical communicating devices;
receiving, by each of the plurality of second optical communicating devices, the first frame and the instruction from the first optical communicating device; and
controlling, by each of the plurality of second optical communicating devices, based on the instruction, whether to transmit the received first frame to the radio communicating device, wherein
the instruction is generated, based on a request from the radio communicating device, such that the first frame is to be transmitted to a mobile terminal device through two or more radio communicating devices.

8. The method according to claim 7, further comprising:
adding, by the first optical communicating device, an identifier of a logical line commonly used among the plurality of second optical communicating devices to the first frame, and transmits the first frame to the plurality of second optical communicating devices; and
deleting, by the second optical communicating device, the identifier from the frame.

9. The method according to claim 7, further comprising:
transmitting, from the second optical communicating device to the first optical communicating device, a second frame including terminal information identifying the mobile terminal device, the terminal information is transmitted from the radio communicating device; and
generating, by the first optical communicating device, the instruction based on the terminal information included in the second frame.

10. The method according to claim 9, further comprising:
transmitting, by the second optical communicating device, a third frame including the request from the radio communicating device to the first optical communicating device.

11. The method according to claim 9, wherein
storing, by the first optical communicating device, a terminal management table defining correspondence relation between each of the plurality of second optical communicating devices and the mobile terminal device based on the terminal information; and
identifying, by the first optical communicating device, two or more radio communicating devices coupled to the two or more second optical communicating devices respectively based on the terminal management table and the terminal information indicated in the request.
